(19) United States
(12) Patent Application Publication
(10) Pub. No.: US 2026/0025837 A1
(43) Pub. Date: Jan. 22, 2026

(54) SYSTEMS AND METHODS FOR MANAGING SIDELINK COMMUNICATIONS

(71) Applicant: ZTE CORPORATION, Shenzhen, Guangdong (CN)

(72) Inventors: Mengzhen LI, Shenzhen (CN); Chuangxin JIANG, Shenzhen (CN); Weimin XING, Shenzhen (CN); Youxiong LU, Shenzhen (CN); Junpeng LOU, Shenzhen (CN); Juan LIU, Shenzhen (CN)

(21) Appl. No.: 18/994,425

(22) PCT Filed: Jul. 15, 2022
(86) PCT No.: PCT/CN2022/106069

§ 371 Date: Jan. 14, 2025

(51) Int. Cl. H04W 72/40; H04B 17/318; H04L 5/00; H04W 64/00; H04W 72/25; H04W 92/18

(52) U.S. Cl. CPC H04W 72/40; H04B 17/328; H04L 5/0051; H04W 64/00; H04W 72/25; H04W 92/18

(57) ABSTRACT

The present disclosure relates to managing sidelink communications between a first wireless communication device and a second communication device. The second wireless communication device receives coordination information for sidelink positioning among a plurality of wireless communication devices from the first wireless communication device. The second wireless communication device determines at least one resource for transmitting sidelink-related data. The second wireless communication device transmits the sidelink-related data using the at least one resource to the first wireless communication device or at least one other wireless communication device.

### CROSS-REFERENCE TO RELATED APPLICATION(S)

The present application is a national phase entry under 35 U.S.C 371 of International Application No. PCT/CN2022/106069, filed on Jul. 15, 2022. The entire contents of the International Patent Application are incorporated herein by reference.

### TECHNICAL FIELD

The disclosure relates generally to wireless communications and, more particularly, to managing sidelink communications.

### BACKGROUND

Sidelink (SL) communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications, which include transmitting data to a BS (e.g., uplink transmissions) and receiving data from a BS (e.g., downlink transmissions). In SL communications, data is transmitted directly from a source UE to a target UE through, for example the Unified Air Interface (e.g., PC5 interface) without passing through a BS.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, a wireless communication method for managing sidelink communications between a first wireless communication device and a second wireless communication device, comprising: receiving, by the second wireless communication device from the first wireless communication device, coordination information for sidelink positioning among a plurality of wireless communication devices; determining, by the second wireless communication device, at least one resource for transmitting sidelink-related data; and transmitting, by the second wireless communication device to the first wireless communication device or at least one other wireless communication device(s), the sidelink-related data using the at least one resource.

In some arrangements, a wireless communication method for managing sidelink communications between a first wireless communication device and a second wireless communication device, comprising: sending, by the first wireless communication device to the second wireless communication device, coordination information for coordinating sidelink positioning among a plurality of wireless communication devices, wherein the second wireless communication device determines at least one resource for transmitting sidelink-related data; and receiving, by the first wireless communication device or at least one other wireless communication device from the second wireless communication device, the sidelink-related data using the at least one resource.

The systems and methods presented herein include a novel approach for supporting sidelink communication. The systems and methods can provide or include various options or schemes can be provided for sidelink positioning reference signal (SL-PRS) inter-UE coordination (IUC). Examples of the SL-PRS IUC schemes can include at least the following.

Arrangement/scheme 1: the SL-PRS IUC information sent/transmitted/provided from UE-A to UE-B can be a set of resources to be recommended (or not recommended) for UE-B SL-PRS and/or SL-data/PSSCH transmission. The SL-PRS IUC information can include/contain/embody a condition or granularity of resource recommendation can be binary or non-binary or reported discretely. The SL-PRS IUC information can include a SL-PRS-Thres-RSRP-List (e.g., a list of reference signal received power (RSRP) thresholds). The SL-PRS IUC information can include additional SL-PRS IUC information. The SL-PRS IUC information can include SL-PRS IUC trigger (e.g., container, field, etc.). The SL-PRS IUC information can include a sensing or selection window's timing relation for a request to trigger SL-PRS IUC transmission. The SL-PRS IUC information can include an SL-PRS IUC report.

Arrangement/scheme 2: the SL-PRS IUC information sent from UE-A to UE-B can include, correspond to, or be a part of a presence of expected, potential, and/or detected resource conflict on the resources which may be indicated or reserved by the UE-B. The SL-PRS IUC information can include at least one physical sidelink feedback channel (PSFCH), such as N slots, slot structure, sequence design, among others. The container of SL-PRS IUC can include, correspond to, or be at least one of the following: PSFCH, MAC CE, SCI, RRC, PC5-RRC, PC5-S, LMF (e.g., LPP signaling), and/or SL-LMF (e.g., SL-LPP signaling), among others.

Arrangement/scheme 3: the SL-PRS IUC information sent from UE-A to UE-B can include one or more suggestions/recommendations for SL-PRS configurations/settings or characteristics of the UE-B. The SL-PRS IUC information can include at least one configuration parameter and/or signaling. The SL-PRS IUC information can include an association (or associated) relationship between the parameter (e.g., configuration parameter) with at least one preference/priority (e.g., selected or preferred parameter).

Arrangement/scheme 4: the SL-PRS IUC transfer framework can be utilized or reused for requesting and/or reporting measurements. For instance, the systems and methods presented herein can provide procedure(s) for utilizing the SL-PRS IUC transfer framework for measurement request and/or report.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a plot illustrating an example of sidelink resource allocation mode 2, according to various arrangements.

FIG. 4 is a flow diagram illustrating an example method or procedure of signaling for a certain SL IUC scheme, according to various arrangements.

FIG. 5 illustrates examples of requesting SL-PRS IUC and reporting SL-PRS IUC, according to various arrangements.

FIG. 6 is a graph illustrating an example of time-frequency resources associated with a binary recommendation level, according to various arrangements.

FIG. 7 is a graph illustrating an example of time-frequency resources associated with a non-binary recommendation level, according to various arrangements.

FIG. 8 is a flow diagram illustrating an example method or procedure for an SL-PRS IUC implementation, according to various arrangements.

FIG. 9 is a diagram illustrating an example SL-PRS IUC scheme triggered by a network, according to various arrangements.

FIG. 10 is a plot illustrating an example of non-overlapping between the selection window for SL-PRS IUC transmission and the selection window for determining resources, according to various arrangements.

FIG. 11 is a plot illustrating an example of partial-overlapping between the selection window for SL-PRS IUC transmission and the selection window for determining resources, according to various arrangements.

FIG. 12 illustrates examples of slot structures in a dedicated SL-PRS resource pool, according to various arrangements.

FIG. 13 illustrates examples of slot structures in a dedicated SL-PRS resource pool with PSFCH occupying more than one symbol, according to various arrangements.

FIG. 14 illustrates examples of slot structures in a dedicated SL-PRS resource pool with more than one PSFCH occupying the frequency domain, according to various arrangements.

FIG. 15 is a flow diagram illustrating an example method or procedure for an SL-PRS IUC information including SL-PRS configurations or characteristics, according to various arrangements.

FIG. 16 is a flow diagram illustrating an example method or procedure for reusing an SL-PRS IUC transfer framework for measurement request and/or report, according to various arrangements.

FIG. 17 illustrates an example of requesting and/or reporting SL-PRS measurement, according to various arrangements.

FIG. 18 is a flow diagram illustrating an example method for managing sidelink communications, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional BS-centric cellular networks have limited high data rate capabilities and support for proximity services. In this context, device-to-device (D2D) communications emerge to address the shortcomings of the BS-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

In the current SL technical solutions, a UE monitoring a measurement resource pool may lead to significant power consumption. Presently, in order to improve the coverage of the UE, the UE accesses the network through a relay UE. The arrangements of the present disclosure allow a UE to conserve energy in an SL system. For example, the network can configure a remote UE when the remote UE accesses the network through a relay UE.

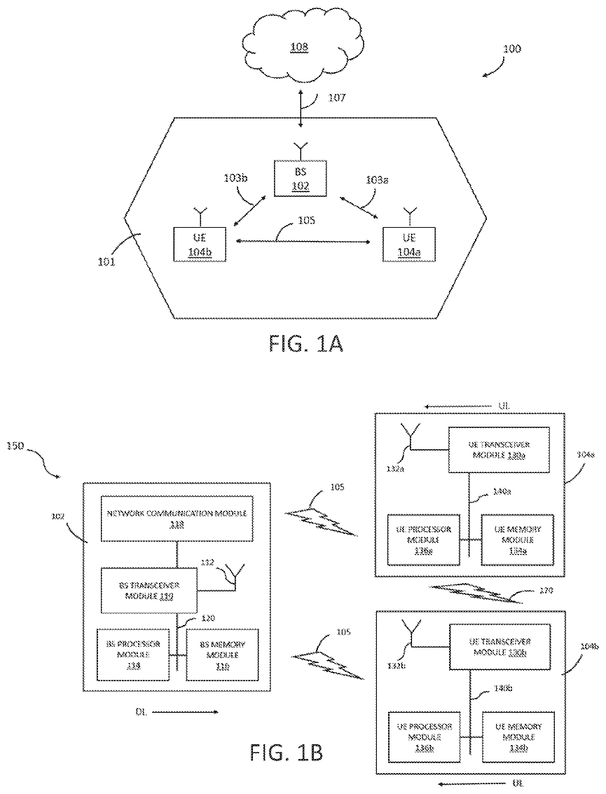

Referring to FIG. 1A, an example wireless communication network 100 is shown. The wireless communication network 100 illustrates a group communication within a cellular network. In a wireless communication system, a network side communication node or a BS can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a BS 102 and UEs 104a and 104b, respectively. In some arrangements, the BS 102 and UEs 104a/104b are sometimes referred to as “wireless communication node” and “wireless communication device,” respectively. Such communication nodes/devices can perform wireless communications.

In the illustrated arrangement of FIG. 1A, the BS 102 can define a cell 101 in which the UEs 104a and 104b are located. The UEs 104a and/or 104b can be moving or remain stationary within a coverage of the cell 101. The UE 104a can communicate with the BS 102 via a communication channel 103a. Similarly, the UE 104b can communicate with the BS 102 via a communication channel 103b. In addition, the UEs 104a and 104b can communicate with each other via a communication channel 105. The communication channels 103a and 103b between a respective UE and the BS can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The BS 102 is connected to Core Network (CN) 108 through an external interface 107, e.g., an Iu interface.

In some examples, a remote UE (e.g., the UE 104b) that does not directly communicate with the BS 102 or the CN 108 (e.g., a link of the communication channel 103b is not established) communicates indirectly with the BS 102 and the CN 108 using the SL communication channel 105 via a relay UE (e.g., the UE 104a), which can directly communicate with the BS 102 and the CN 108 or indirectly communicate with the BS 102 and the CN 108 via another relay UE that can directly communicate with the BS 102 and the CN 108.

FIG. 1B illustrates a block diagram of an example wireless communication system 150 for transmitting and receiving downlink, uplink and SL communication signals, in accordance with some arrangements of the present disclosure. In some arrangements, the system 150 can transmit and receive data in a wireless communication environment such as the wireless communication network 100 of FIG. 1A, as described above.

The system 150 generally includes the BS 102 and UEs 104a and 104b, as described in FIG. 1A. The BS 102 includes a BS transceiver module 110, a BS antenna 112, a BS memory module 116 (also referred to as memory module 116), a BS processor module 114 (also referred to as processor module 114), and a network communication module 118 (also referred to as network interface 118), each module being coupled and interconnected with one another as necessary via a data communication bus 120. The UE 104a includes a UE transceiver module 130a, a UE antenna 132a, a UE memory module 134a (also referred to as memory module 134a), and a UE processor module 136a (also referred to as processor module 136a), each module being coupled and interconnected with one another as necessary via a data communication bus 140a. Similarly, the UE 104b includes a UE transceiver module 130b, a UE antenna 132b, a UE memory module 134b (also referred to as memory module 134b), and a UE processor module 136b (also referred to as processor module 136b), each module being coupled and interconnected with one another as necessary via a data communication bus 140b. The BS 102 communicates with the UEs 104a and 104b via one or more of a communication channel 105 (also referred to as wireless communication channel 105 or wireless data communication channel 105), which can be any wireless channel or other medium known in the art suitable for transmission of data as described herein.

The system 150 may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the BS 102 is known as an uplink transmission, and a wireless transmission from an antenna of the BS 102 to an antenna of one of the UEs 104a and 104b is known as a downlink transmission. In accordance with some arrangements, each of the UE transceiver modules 130a and 130b may be referred to herein as an uplink transceiver, or UE transceiver, or a transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver, or a transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 105 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channel 105. The wireless communication channel 105 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the BS transceiver 110 are configured to communicate via the wireless data communication channel 105, and cooperate with a suitably configured antenna arrangement that can support a particular wireless communication protocol and modulation scheme. In some arrangements, the UE transceiver 130a and 130b and the BS transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the BS transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

In some arrangements, each of the UEs 104a and 104b can operate in a hybrid communication network in which the UE communicates with the BS 102, and with other UEs, e.g., between 104a and 104b. As described in further detail below, the UEs 104a and 104b support SL communications with other UE's as well as downlink/uplink communications between the BS 102 and the UEs 104a and 104b. In general, the SL communication allows the UEs 104a and 104b to establish a direct communication link with each other, or with other UEs from different cells, without requiring the BS 102 to relay data between UEs.

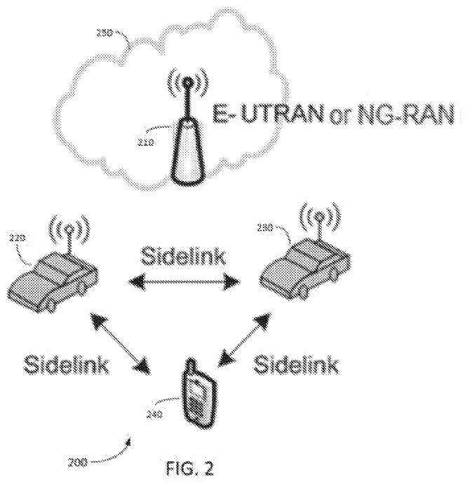

FIG. 2 is a diagram illustrating an example system 200 for SL communication, according to various arrangements. As shown in FIG. 2, a BS 210 (such as BS 102 of FIG. 1A) broadcasts a signal that is received by a first UE 220, a second UE 230, and a third UE 240. The UEs 220 and 230 in FIG. 2 are shown as vehicles with vehicular communication networks (e.g., be a part of or correspond to the vehicles), while the UE 240 is shown as a mobile device. In some cases, the UEs 220, 230, and 240 can correspond to or be part of a roadside unit (RSU), a positioning reference unit (PRU), or any other types of UE, which can support V2X communication and/or sidelink communication. The UEs 220, 230, and 240 can be associated with a known location (e.g., the location of the UE is known or identifiable) or may not be associated with a known location (e.g., the location of the UE is not known). As shown by the SLs, the UEs 220-240 are able to communicate with each other (e.g., directly transmitting and receiving) via an air interface without forwarding by the base station 210 or the core network 250. This type of V2X communication can be referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

For purposes of providing examples herein, the SL-PRS IUC can represent inter-UE coordination for sidelink positioning. The SL-PRS can include or be associated with any type of design configured to provide the features, functionalities, or operations discussed herein. For example, the SL-PRS can be a new reference signal for SL positioning using PRS (Positioning Reference Signal)/SRS (Sounding Reference Signal) design and SL design framework as a starting point, without preclusion of an existing SL reference signal for SL positioning.

As discussed herein, the term/wording “sidelink data,” “SL-data,” “SL-data/PSSCH,” and “PSSCH/PSCCH (Physical Sidelink Control Channel)” can be used interchangeably and/or may provide a similar description. The term “sidelink data resource,” “SL-data resource,” “SL-data/PSSCH resource,” and “PSSCH/PSCCH resource” can be used interchangeably and/or represent resources used for sidelink communication. The term “sidelink-related data” may include, represent, or indicate at least one of or both SL-PRS and/or SL-data. The term sidelink control information (SCI) may include or represent at least one of or all of the first stage SCI, the second stage SCI, and/or SCI dedicated for SL-PRS.

Further, UE-A described herein can represent or correspond to the UE 104 (e.g., a first or second wireless communication device) that sends/transmits/provides/forwards/signals SL-PRS IUC information to UE-B. The UE-B can represent or correspond to the UE 104 (e.g., the other second or first wireless communication device) that receives/obtains/retrieves/collects SL-PRS IUC information from the UE-A. The UE-B can intend or be configured to transmit SL-PRS and/or SL-data (or PSSCH) (e.g., sometimes referred to generally as sidelink-related data or information). The sidelink-related data transmission of the UE-B can be unicast, group-cast, or broadcast. The UE-A can be either a destination UE 104 of at least one transport block (TB) transmitted by the UE-B or a non-destination UE 104 of a TB transmitted by the UE-B. In various aspects, the resource pool can represent at least one of or both of SL-PRS resource pool and sidelink resource pool, for example.

In some SL communication systems and in regard to the sidelink positioning reference signal (SL-PRS) resource allocation, the network controlling (e.g., similar to a first legacy mode) and the UE autonomous SL-PRS resource allocation (e.g., similar to a second legacy mode) can be considered in certain systems. The inter-UE coordination (IUC) information (e.g., sometimes referred to as coordination information) transfer/communication for sidelink positioning among a number of UEs 104 can be beneficial for maximum resource utilization and/or minimum resource conflicts. For example, at least one UE 104 can determine one or more resource conflicts or determine whether a set of resources are recommended for transmission/communication of another UE 104. Subsequently, the UE 104 can consider the IUC information for sidelink positioning before or prior to transmission. As discussed herein, systems, methods, and/or apparatuses can provide procedures/operations/processes of signaling to specify inter-UE coordination for sidelink positioning.

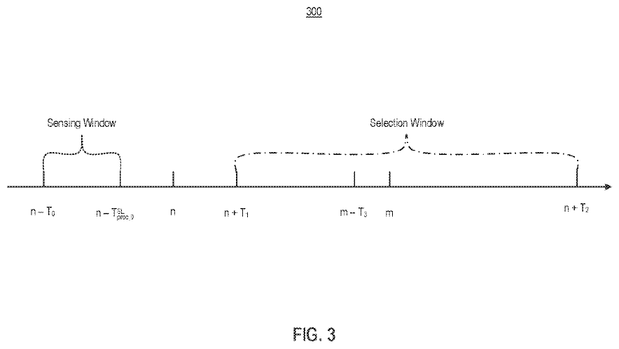

In sidelink (e.g., SL-PRS) resource allocation mode 1, the network (e.g., CN 108 or BS 102) can schedule one or more sidelink resources for the UEs 104. Referring to FIG. 3, depicted is a plot 300 illustrating an example of sidelink resource allocation mode 2. The sidelink resource allocation mode 2 can be a contention-based scheme with UE selecting sidelink control and data resources for its transmission. In resource allocation mode 2, the higher layer can request UE to determine a subset of resources from which the higher layer will select resources for PSSCH/PSCCH transmission. The UE 104 can select one or more resources in the selection window based on the sensing result of the PSCCH/PSSCH in its transmitting resource pool.

In the sidelink resource allocation mode 2, one or more inter-UE coordination (IUC) schemes/options/aspects can be supported. For example, in a first type or implementation of IUC coordination (e.g., IUC scheme 1), the coordination information sent/communicated/transmitted from UE-A to UE-B can be the set of resources preferred and/or non-preferred for UE-B transmission. The types of coordination information can include a preferred resource set and/or non-preferred resource set.

In the preferred resource set, the UE-A can consider/take any resource(s) satisfying the condition(s) as a set of resource(s) preferred for UE-B transmission. In this case, the first condition (e.g., condition 1-A-1) can include resource(s) (e.g., excluding resource(s) overlapping with one or more reserved resources of other UEs) identified by the UE-A including or is/are associated with RSRP measurement that is greater than (or in some cases equal to) an RSRP threshold. The second condition (e.g., condition 1-A-2) can include resource(s) excluding resource(s) (e.g., slot(s)) where UE-A, when the UE-A is the intended receiver of the UE-B (e.g., UE-B transmission), does not expect to perform sidelink (SL) reception from UE-B due to or because of half-duplex operation. Other conditions can be considered for the preferred resource set.

In the non-preferred resource set, the UE-A can consider any resource(s) that satisfies at least one of the condition(s) as a set of resource(s) not preferred for the UE-B transmission. For example, a first condition (e.g., condition 1-B-1) can include reserved resource(s) of other UEs 104 identified by the UE-A from the SCI (sidelink control information) (e.g., including priority field) and RSRP measurement of one or more other UEs 104. A second condition (e.g., condition 1-B-2) can include resource(s) (e.g., slot(s)) where the UE-A, when the UE-A is the intended receiver of UE-B, does not expect to perform SL reception from UE-B due to half-duplex operation.

The coordination information can be sent from the UE-A to the UE-B in response to a trigger (e.g., triggering of a report). For example, the transmission of the coordination information can be triggered by an explicit request (e.g., request or signal to the UE-A). In another example, the transmission can be triggered by at least one condition other than explicit request reception.

In a second type or implementation of IUC coordination (e.g., IUC scheme 2), the coordination information transmitted from the UE-A to UE-B can be the presence of expected/potential resource conflict on the resources indicated by the SCI of the UE-B. In this case, as a first condition (e.g., condition 2-A-1), the reserved resource(s) of other UEs 104 identified by the UE-A can be fully or partially overlapping with resource(s) indicated by the UE-B SCI in the time-and-frequency domain. As a second condition (e.g., condition 2-A-2), resource(s) (e.g., slot(s)) where the UE-A, when it is the intended receiver of UE-B (e.g., transmission), does not expect to perform SL reception from the UE-B due to half-duplex operation.

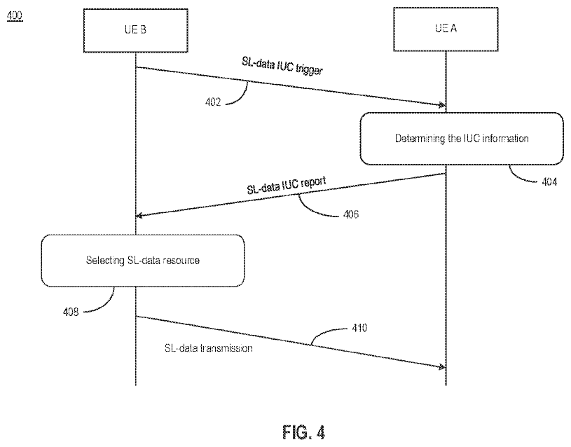

Referring to FIG. 4, depicted is a flow diagram illustrating an example method 400 of signaling for a certain SL IUC scheme. The procedure(s) of SL IUC signaling for certain systems (e.g., in arrangement 1) can be shown. In this case, the UE-B can correspond to or represent the UE 104 configured to transmit/send/provide SL-data, and the UE-A can represent the UE 104 that is configured to provide IUC information. For example, the IUC information can be triggered (e.g., SL-data IUC trigger) by an explicit request (402) or a condition other than explicit request reception. The UE-A can determine the IUC information (e.g., preferred or non-preferred resource set) as requested by the UE-B or by the UE-A implementation/configuration (404). In response to determining the IUC information, the UE-A can report to the UE-B with the SL-data IUC information (406). The UE-B can utilize the IUC information to determine UE-B transmission resource selection or reselection (408). Hence, based on the SL-IUC mechanism or operations, the UE-B can signal or transmit SL-data (e.g., SL-PRS IUC) to the UE-A (410).

### Implementation 1

In various implementations, the SL-PRS IUC information sent from the UE-A to the UE-B can correspond to or include a set of resources to be recommended or not to be recommended for UE-B SL-PRS and/or SL-data/PSSCH transmission. To achieve/provide high positioning measurement accuracy and/or avoid resource collision, the use cases/scenarios of SL-PRS IUC can include or correspond to at least one of the following:
Case 1: For an SL-PRS transmission of the UE 104, because conflict may occur/happen between SL-PRS resources among a number of UEs 104 and/or between SL-PRS resources and SL-data/PSSCH resources among a number of UEs 104, the SL-PRS IUC information from another UE(s) 104 can be applied/utilized and/or requested/reported to assist the UE SL-PRS resource transmission.
Case 2: For an SL-data/PSSCH transmission of the UE 104, due to the potential conflicts which may occur between SL-data/PSSCH resources among a number of UEs 104 and/or between SL-PRS resources and SL-data/PSSCH resources among a number of Ues 104, SL-PRS IUC information from another UE(s) 104 can be applied and/or requested/reported to assist SL-data/PSSCH resource transmission for the UE 104.
Case 3: For the combination of cases 1 and 2, for the SL-PRS and SL-data/PSSCH transmission of the UE 104, to avoid conflicts for instance between SL-data/PSSCH resources among a number of Ues 104, between SL-PRS resources among a number of Ues 104, and/or between SL-PRS resources and SL-data/PSSCH resources among a number of UEs 104, the SL-PRS IUC information from another UE(s) 104 can be applied and/or requested/reported to assist SL-PRS and/or SL-data/PSSCH resource transmission for the UE 104.

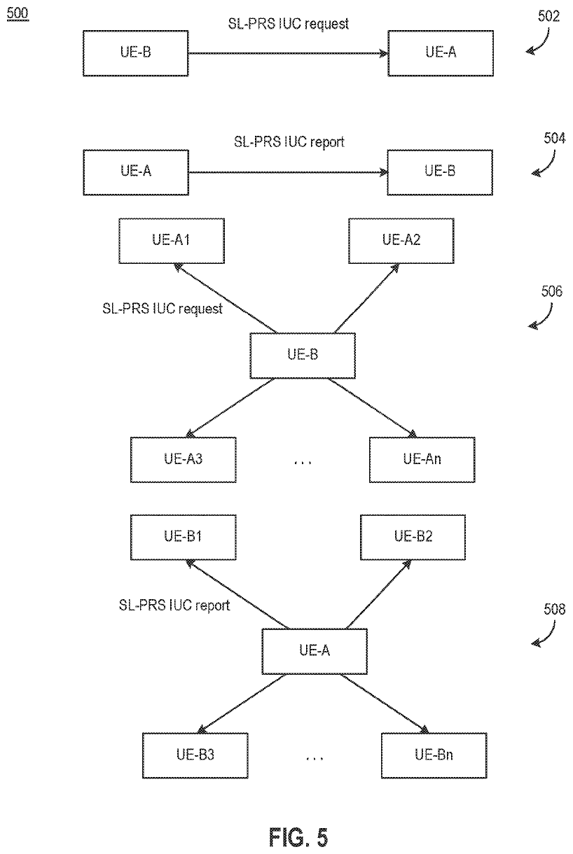

The systems and methods discussed herein can include the SL-PRS IUC that is sent/transmitted/provided from the UE-A to the UE-B for UE-B transmission. The cast type of SL-PRS IUC request/report can be at least one of a unicast, groupcast, and/or broadcast. In some cases, groupcast can correspond to broadcast. Referring to FIG. 5, depicted are examples 500 of requesting SL-PRS IUC and/or reporting SL-PRS IUC. In various implementations, the UE-B can request SL-PRS IUC from (e.g., transmit a request to) the UE-A (502). The UE-A can report/transmit the SL-PRS IUC to the UE-B (504). In some arrangements, the UE-B can groupcast/broadcast the SL-PRS IUC request(s) to multiple UE-As (e.g., UE-A1, UE-A2, UE-A3, etc.) (506). In response to the request, one or more UE-As can report the SI-PRS IUC to the UE-B (508).

To maximize resource utilization and/or minimize resource conflicts, the UEs 104 can exchange/communicate SL-PRS IUC information. Various schemes/options/implementations can be considered/utilized for exchanging SL-PRS IUC information. For example, in some arrangement (e.g., for simplicity, can be referred to as arrangement 1), the SL-PRS IUC information sent from the UE-A to the UE-B can correspond to or include a set of resources to be recommended or not to be recommended for UE-B SL-PRS and/or SL-data/PSSCH transmission. In some implementations (e.g., for simplicity, can be referred to as arrangement 2), the SL-PRS IUC information sent from UE-A to UE-B can include the presence of expected, potential, and/or detected resource conflict at least on the resources which have been indicated or reserved by the UE-B. In some aspects (e.g., for simplicity, can be referred to as arrangement 3), the SL-PRS IUC information sent from UE-A to UE-B can include one or more suggestions/recommendations for UE-B SL-PRS configurations/characteristics/parameters. In various arrangements (e.g., for simplicity, can be referred to as arrangement 4), the SL-PRS IUC transfer framework can be reused/looped for measurement requests and/or reports (e.g., requesting or reporting measurement(s)).

The UE 104 can be configured with different higher layer parameters (e.g., higher layer signaling) from at least of the options for exchanging SL-PRS IUC information. The higher layer parameter can include or correspond to at least one of medium access control (MAC) layer, radio resource control (RRC) layer, application layer, and/or new higher layer similar to location management function (LMF) in certain positioning protocols, such as SL-LMF. Additionally or alternatively, the SL-PRS IUC scheme type can be indicated in the SCI. The SL-PRS IUC scheme type may be indicated/provided/communicated along with SL-PRS IUC request/report/trigger signaling (e.g., MAC control element (CE), SCI, higher layer signaling, such as PC5-RRC, PC5-S, SL-LTE positioning protocol (LPP), among others). In various implementations, the UE 104 can report the supported SL-PRS IUC scheme as a capability to the UE 104 (e.g., wireless communication device), LMF, or BS 102 (e.g., gNB or wireless communication node).

The SL-PRS IUC can be transmitted from the UE-A to UE-B to assist UE-B SL-related data transmission (e.g., SL-data transmission to the UE-A). The UE-A may be at least one of the destination UE 104 of the UE-B sidelink-related data transmission or may not be the destination UE 104. As used herein, the terms/wording “favored or disfavored,” “recommended or not recommended,” and/or “preferred or non-preferred” can be similar to each other, among other interchangeable terms.

In various implementations (e.g., for arrangement 1), the SL-PRS IUC information sent from the UE-A to UE-B can include the set of resources to be recommended or not-recommended for UE-B SL-PRS transmission and/or SL-data/PSSCH transmission. The condition/parameter/granularity of resources recommendation can be binary or non-binary, and/or reported discretely by the respective region.

### Binary Resource Recommendation

For binary resource recommendation, the SL-PRS IUC information can include a set of SL-PRS resources preferred and/or non-preferred. With at least one resource partially or fully overlapping with at least one other UE transmission resource (e.g., detected by the UE-A), the resource(s) for UE-B SL-PRS (or SL-data) transmission in the selection window can be recognized as non-preferred resource(s).

Preferred resource(s) can include or correspond to any resource(s) satisfying at least one of (or all of) the following condition(s) as a set of resource(s) preferred for UE-B SL-PRS transmission or SL-data transmission.
Resource(s) excluding those overlapping with the reserved resource(s) (e.g., including SL-data resource and/or SL-PRS resource) of other UEs 104 identified by UE-A whose RSRP measurement is greater than (or in some cases equal to) a RSRP threshold
   The RSRP threshold can be indicated by or in SL-PRS-Thres-RSRP-List. For example, the SL-PRS-Thres-RSRP-List can provide a list of thresholds, where each threshold may be selected based on the priority of the received SL-related data and/or the priority of the SL-related data to be transmitted/sent. In some cases, the the list can be considered as or correspond to a table/metric, such as having dimension n*m. In this case, n and m can represent the respective configurable number of the priority value. The list can be generated by higher layer or preconfigured for each resource pool. Once the UE 104 obtain/get the two priorities (e.g., values of n and/or m) and the corresponding RSRP threshold, the UE 104 can compare the threshold with the actual measured RSRP. The RSRP threshold can be configured on at least one of MAC layer, RRC layer, PC5-RRC, PC5-S, application layer, and/or new higher layer similar to LMF in a certain positioning protocol, such as SL-LMF or configured in each sidelink resource pool (e.g., SL-data resource pool and/or SL-PRS resource pool).
   If the priority of SL-PRS is indicated in SCI (e.g., including at least one of or both the first stage SCI and/or the second stage SCI or SL-PRS SCI), the threshold can be selected/chosen based on the priority prioᵢ (e.g., SL-PRS or SL-data) in the decoded SCI. The priority prioⱼ (e.g., SL-PRS or SL-data) in the SCI can be transmitted subsequent to selecting the threshold. A resource may be excluded if the resource is indicated or reserved by a decoded SCI or SL-PRS SCI and/or SL-PRS RSRP in the associated data resource is greater than (or sometimes equal to) the RSRP threshold. The priority of the SL-PRS may be (pre-) configured by the network (e.g., BS 102, gNB, and/or LMF) and/or the higher layer of the UE 104.
   The RSRP threshold (e.g., sometimes labeled as Th (prioᵢ, prioⱼ)) can be set to the corresponding value of the RSRP threshold indicated in the SL-PRS-Thres-RSRP-List.
   The number of SL-PRS-Thres-RSRP-List can be related to the number of (e.g., optional) values of priority including prioᵢ and prioⱼ. For example, with the number of (e.g., optional) configured SL-PRS priority value(s) is N, if both prioᵢ and prioⱼ are SL-PRS priority, the number of threshold lists can be N\hat{ }2. If one of prioᵢ and prioⱼ is SL-PRS priority and the other is SL-data priority (e.g., 8 priority value), the number of threshold lists can be N*8.
Resource(s) excluding those with priority value greater/larger than the priority of other UEs 104 identified by UE-A (e.g., if provided). For instance, the transmission of one or more other UEs 104 can be or take precedence (e.g., prioritized) over the UE-B transmission.
Set a distance threshold. The distance threshold can be (pre-) configured on at least one of: the MAC layer, RRC layer, application layer, and/or a new higher layer, where the new higher layer can be similar to LMF in a certain positioning protocol, such as SL-LMF. The range ambiguity may be reported. The following can be considered or taken into account when setting the distance threshold:
   The distance threshold can be contained in SL-PRS IUC trigger signaling.
   Preferred resources excluding one or more conflicting resources if the distance between UE-B and one or more other UEs 104 is not larger/greater than the distance threshold and/or if the distance between UE-A and other UEs 104 is not greater than the distance threshold.
   If the distance between UE-B and UE-A (e.g., among other UE) is greater than (or in some cases equal to) the distance threshold, the UE-A can recognize or determine that the resources conflicting with the UE-B are preferred. For example, the IUC information that the UE-A reports may exclude/ignore the conflict information if the distance between the UE-A (or another UE 104) and the UE-B is greater than or equal to a threshold.
   If the distance between UE-B and UE-A (or another UE 104 different from the UE-B) is provided in the IUC information, the UE-B can choose/determined to (e.g., depending on the UE-B implementation) utilize the preferred resources indicated in the IUC information.
Half-duplex limit: Resource(s), such as excluding slot(s) (or resource(s)) where the UE-A, when intended as the receiver of the UE-B, does not expect to perform SL reception or SL-PRS reception from UE-B due to half-duplex operation.

In various implementations, non-preferred resource(s) (e.g., disfavored or not recommended resource(s)) can include or correspond to any resource(s) satisfying at least one of (or all of) the following condition(s) as a set of resource(s) not preferred for UE-B transmission (e.g., sidelink-related data transmission).
Resource conflict based on RSRP measurement:
   Option 1: Reserved resource(s) (e.g., including SL-data resource and/or SL-PRS resource) of another UE(s) identified by UE-A whose RSRP measurement is greater than (or sometimes equal to) a (pre-) configured RSRP threshold, which can be determined by at least the priority value of the UE(s) 104. The priority value can be indicated/provided/included by or in SCI and/or configured/preconfigured by the network or UE higher layer).
      If the priority of the SL-PRS is indicated in the SCI (e.g., including at least one of or both of the first stage SCI and the second stage SCI and/or the SL-PRS SCI), the RSRP threshold (e.g., sometimes labeled or indicated as thresholdSL-PRSRSRPOption1Scheme1) can be at least one of the following: (1) the threshold can be related to or associated with Prio_{RX}, where Prio_{RX} corresponds to a value of the priority field in the received SCI, and/or (2) the threshold can be selected/picked/determined based on the priority in the decoded SCI and/or the priority in the SCI to be transmitted. In some cases, instead of SCI, the priority of SL-PRS may be (pre-) configured by the network (e.g., BS 102, gNB, and/or LMF) or the higher layer of the UE 104.
   Option 2: Reserved resource(s) (e.g., including SL-data resource and/or SL-PRS resource) of another UE 104 identified by UE-A whose RSRP measurement is less than (or sometimes equal to) a (pre-) configured RSRP threshold which may be determined by at least the priority value indicated by SCI of the UE(s) 104, such as when the UE-A is a destination of a TB transmitted by one or more other UE(s) 104 (e.g., UE-B, etc.).
      If the priority of SL-PRS is indicated in SCI (including both 1^{st} stage SCI and 2^{nd} stage SCI or SL-PRS SCI), the RSRP threshold (e.g., thresholdSL-PRSRSRPOption2Scheme1) can be at least one of the following: (1) it is only related to Prio_{RX}, where Prio_{RX} is the value of the priority field in the received SCI. (2) The threshold should be selected based on the priority in the decoded SCI and the priority in the SCI to be transmitted. Otherwise, instead of SCI, the priority of SL-PRS may also be (pre-) configured by network (gNB or LMF)/UE's higher layer.
   The priority value of UE-B's transmitting resource is larger than the priority of other UE identified by UE-A if provided. In other words, other UE's transmission takes precedence over UE-B's transmission
   Set a distance threshold, the distance threshold can be configured on at least one of: MAC layer, or RRC layer or application layer, new higher layer similar as LMF in legacy positioning protocol like SL-LMF. Consider at least one of the following:
      The distance threshold can be contained in SL-PRS IUC trigger signaling.
      If the distance (optional with range ambiguity) between UE-B and other UE is no larger than the distance threshold, UE-A can recognize those resources conflicting with UE-B are non-preferred. In other words, the IUC information that UE-A reports includes the conflict information if the distance is within a threshold.
      If the distance between UE-B and other UE is larger than the distance threshold and UE-A is a destination of a TB transmitted by the other UE, UE-A may recognize those resources conflicting with UE-B as non-preferred.
      If the distance between UE-B and other UE is provided in IUC information, UE-B can choose to (It is up to UE-B's implementation) use the non-preferred resources indicated in the IUC information.
Half-duplex limit: Resource(s) (e.g., slot(s)) where UE-A, when it is intended as the receiver of UE-B, does not expect to perform SL reception or SL-PRS reception from UE-B due to half duplex operation (e.g., resource determined based on a half-duplex limit).

The SL-PRS IUC information (e.g., coordination information) may include additional resources or data from the preferred and/or non-preferred resources. For instance, the IUC information can include/contain at least one of the following additional SL-PRS IUC information.
For the selection window of UE-B (e.g., second wireless communication device) for determining resources, UE-A (e.g., first wireless communication device) can report the time-domain and/or frequency-domain locations of at least one of the preferred (e.g., favored) and/or non-preferred (e.g., disfavored) resources for the UE-B. Location includes the time-domain range and frequency range.
The time and frequency resource conflict ratio.
Sequence preference indication, which can indicate information regarding/about the sequence that is preferred and/or the sequence that is not preferred.
One or more physical resource blocks (PRBs) that may be preferred (e.g., do not cause conflict issue) and/or one or more PRBs that are not preferred.
An RSRP measurement result (e.g., measurement information) from at least one other UE 104 (e.g., third wireless communication device) different from the UE-A (and/or the UE-B).
The transmission priority of SL-PRS and/or SL-data from other UEs 104, such as included in SCI and/or SL-PRS SCI of other UE 104 and decoded by the UE-A.
The UE identifier (ID) information and/or distance/location information (e.g., destination ID, source ID, zone ID, communication range requirement, among others) of SL-PRS and/or SL-data from other UEs 104, such as included in the SCI and/or SL-PRS SCI from other UEs 104 decoded by UE-A.
UE-A intended transmission time and/or frequency location/position.

In various implementations, the SCI can be used for scheduling and/or decoding of the PSSCH. For SL-PRS transmission, the SCI (e.g., extended from a certain system, such as legacy SCI may be used by adding certain fields for SL-PRS, or a new dedicated format SL-PRS SCI) may be introduced/provided for scheduling and/or decoding of SL-PRS. Hence, the UE decoding can be considered as at least one of (or both of) SCI and/or SL-PRS SCI.

In some arrangements, the UE-B can determine/decide how to use the additional IUC information (e.g., coordination information from the UE-A), such as when the type of resource(s) is regarded as non-preferred. For example, subsequent to the UE-A IUC report that the resource(s) in the selection window for the UE-B are non-preferred (e.g., disfavored), once the UE-B receives the additional SL-PRS IUC information, the UE-B may determine to use at least a portion of the resources (e.g., excluding the conflict resource, when time-frequency conflict ratio is lower/less than a threshold, picking certain sequence and PRB(s), considering RSRP measurement, considering distance restriction, without considering the conflict when the distance between the two UEs 104 is greater/longer than a threshold, and/or considering UE ID information, such as the source ID and/or destination ID, etc.). The decision/determination for utilizing the additional IUC information can be made on the higher layer of the UE 104, for example, including at least one of MAC layer, RRC layer, application layer, and/or a new higher layer (e.g., similar to LMF in a certain positioning protocol, such as SL-LMF).

### Non-Binary Resource Recommendation

In the non-binary resource recommendation, the UE-A can provide a certain recommendation level included in the IUC information to the UE-B. One or more resources can be reported along with at least one (e.g., a single) recommendation level. Several recommendation levels can be set, for instance, in consideration of at least one of the following:
The recommendation level can be represented by soft value indicators (e.g., [0, 1]).
For the recommendation level, at least one indicator (e.g., a single indicator) can be reported and the supported values can be (e.g., included or a part of) a discrete set in the interval [a, b].
   The interval [a, b] can correspond to or be represented as [0, 1], among other similar representations.
   The number of discrete values can be reported by the UE 104 and/or configured by the LMF, BS 102 (e.g., gNB), and/or UE 104.
   In some cases, if [a, b] corresponds to or equal [0, 1], the soft values can be set in steps/sequence/increments of 0.1: [0, 0.1, 0.2, . . . , 0.9, 1].
The value range of the recommendation level can be set up or configured to Nr, where Nr can be one of 2, 3, 4, 5, 6, 7, 8, 9, 10, 11, 12, 13, etc. The Nr can be (pre-) configured on at least one of: the MAC layer, RRC layer, PC5-RRC, PC5-S, application layer, and/or new higher layer (e.g., similar to LMF in a certain positioning protocol, such as SL-LMF). The UE 104 can report its supported recommendation level range as a part of the UE capability.
In some cases, the UE 104 can request for a certain recommendation level range.
A recommendation level threshold can be (pre-) configured on at least one of: the MAC layer, RRC layer, PC5-RRC, PC5-S, application layer, and/or new higher layer.
A higher recommendation level can indicate a higher recommendation priority, and a lower recommendation level can indicate a lower recommendation priority. For example, a recommendation level of 0 can indicate non-preferred, a recommendation level of 1 can indicate slightly preferred, a recommendation level of 2 can indicate preferred, and/or a recommendation level of 3 can indicate strongly preferred.
   When the recommendation level is greater than (or equal to) a recommendation threshold, the UE-B can use the SL-PRS IUC information associated with the recommendation level as the preferred resource(s). Otherwise, the SL-PRS IUC information may exclude the corresponding resources.
   The recommendation threshold can be related to a certain range of recommendation levels.
In some implementations, a lower recommendation level may indicate a higher recommendation priority. For instance, a recommendation level of 3 can indicate non-preferred (e.g., resource(s)), a recommendation level of 2 can indicate slightly preferred, a recommendation level of 1 can indicate preferred, and/or a recommendation level of 0 can indicate strongly preferred.
   When the recommendation level is less/lower than (or equal to) a threshold, the UE-B can use the SL-PRS IUC information as the preferred resource(s). Otherwise, the SL-PRS IUC information may exclude the corresponding resource(s).
   The recommendation threshold can be related to a certain range of recommendation levels.

The recommendation level can be related to or associated with at least one of the following:
The time and/or frequency domain locations of preferred and/or non-preferred resources for UE-B selection window. The location can include the time-domain range and frequency-domain range.
The time and frequency resource conflict ratio.
Sequence preference: information regarding at least one sequence that is preferred and/or at least one sequence that is not preferred.
The number of PRB(s) that do not have conflict issues (e.g., preferred PRB(s)) and/or the number of PRB(s) that are not preferred.
The RSRP measurement results or information from other UEs 104 derived/determined/identified from the UE-A.
The transmission priority of the SL-PRS and/or SL-data of at least one other UE 104 which can be included/provided/indicated in the SCI or SL-PRS SCI of the other UEs 104 and/or decoded by UE-A.
The UE ID information and/or distance/location information (e.g., destination ID, source ID, zone ID, communication range requirement, among others) of the SL-PRS and/or SL-data of other UEs 104 which can be included in SCI or SL-PRS SCI of other UEs 104 and decoded by UE-A.
The intended transmission time and frequency location of the UE-A and whether at least one PRB (or slot) can perform reception (e.g., receive information) for the UE-A.

The UE-A can consider at least one of or all of the information discussed above. Based on the information, the UE-A can determine the corresponding recommendation level. The decision or determination of the recommendation level can be made/performed/executed by the respective implementation or higher layer of the UE-A. The higher layer can be at least one of: the MAC layer, PC5-RRC, PC5-S, RRC layer, application layer, and/or new higher layer (e.g., LMF in a certain positioning protocol, such as SL-LMF).

### Resource Recommendation by Partitioning/Region

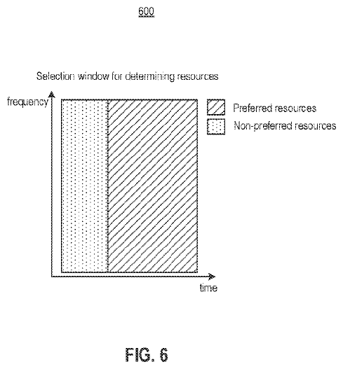

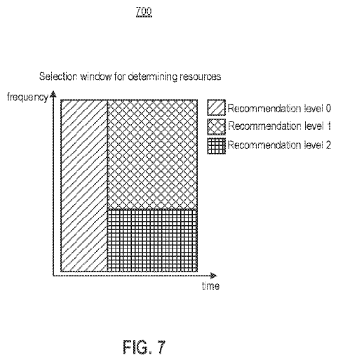

In various implementations, the resource recommendation indication (e.g., at least one of binary or non-binary recommendation levels) can be reported discretely and based on certain time-frequency resources. FIG. 6 is a graph 600 illustrating an example of time-frequency resources associated with a binary recommendation level. FIG. 7 is a graph 700 illustrating an example of time-frequency resources associated with a non-binary recommendation level. As shown in FIGS. 6-7, the time-domain and frequency-domain locations of resources in the UE-B selection window can be reported along with certain recommendation levels. Further, the time and frequency resources can be associated with UE-A (or at least one other UE 104 detected by the UE-A) SL resource pool and/or SL-PRS resource pool (e.g., at least one of dedicated resource pool and/or shared resource pool with sidelink communication). For instance, the resource pool index and/or SL-PRS resource pool index can be reported along with certain recommendation levels, as shown in conjunction with FIGS. 6-7.

### A Combination Solution for Resource Recommendation

The UE 104 can report its capability to one or more other UEs 104. For example, the UE 104 can report its capability to support one or more types of resource recommendation granularity. The UE 104 can report one or more of the capabilities according to at least one of various coordination information reporting methods/procedures, such as at least one of binary, non-binary, binary by region, and/or non-binary by region, among others.

The UE 104 can request or report a certain preferred type of resource recommendation granularity. For the UE 104, the network (e.g., LMF, gNB, and/or BS 102) or the UE 104 (e.g., through/via higher layer signaling, such as SL-LPP, PC5-RRC, PC5-S, MAC CE, and/or lower layer signaling (e.g., SCI)) can (pre-) configure SL-PRS IUC resource recommendation granularity.

In some implementations, if at least one of the UE 104 does not report any preference (e.g., favor) for resource recommendation granularity and/or the UE 104 is not provided a configuration for the type of resource recommendation granularity from the network (e.g., the BS 102 and/or LMF) or from the UE 104, the binary resource recommendation reported per selection window (e.g., the whole/entire selection window) can be treated as a default configuration.

### Implementation 2

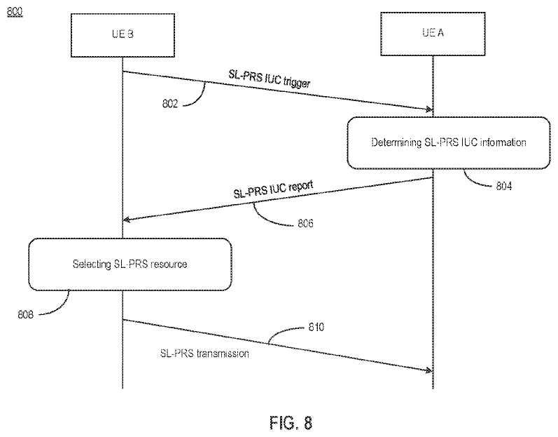

Referring to FIG. 8, depicted is a flow diagram illustrating an example method 800 or procedure for an SL-PRS IUC implementation. As shown (e.g., for arrangement 1), the SL-PRS IUC transmission procedure/operation/process for resource recommendation for a certain case/configuration/implementation/arrangement (e.g., case 1 or a first arrangement) is provided. One or more other arrangements (e.g., case 2 and/or case 3) may share one or more similar steps as case 1, such as at least one of SL-PRS IUC trigger (802), determining SL-IUC information (e.g., or SL-PRS IUC information) (804), SL-IUC report (806), selecting SL-PRS/SL-data resource (808), and/or SL-PRS/SL-data resource transmission (810). For transmission of the SL-related information (e.g., SL-PRS/SL-data), UE-B may additionally (or alternatively) transmit SL-PRS/SL-data resource (e.g., SL-related information) to one or more UEs 104 other than UE-A. In various arrangements, the SL-PRS IUC information can be triggered by at least one of an explicit request, a condition, and/or the network (e.g., BS 102, gNB, or LMF).

### Triggered by Explicit Request

The container of an explicit SL-PRS IUC request from UE-B to UE-A can include or correspond to at least one of the following:
MAC CE can be used as the container of an explicit SL-PRS IUC request transmission from UE-B to UE-A.
SCI can be used as the container of an explicit SL-PRS IUC request transmission from UE-B to UE-A.
   For example, the SCI can include at least one exclusive second stage SCI format for SL-PRS IUC information requests and reports.
      Dedicated SL-PRS pool with control signaling SL-PRS SCI.
      Shared resource pool with SL communication. Introducing a new second stage SCI format.
   In another example, an SCI 2-C introduced in a certain system can be used as the container, with an addition of the field “SL-data/SL-PRS IUC indicator”.
      Four cases: SL-data IUC request, SL-data IUC report, SL-PRS IUC request, and/or SL-PRS IUC report.
      For each case, the corresponding fields in SCI 2-C can be activated/enabled and other irrelevant fields in SCI 2-C may be deactivated/disabled.
When both of MAC CE and SCI are used as the container of an explicit SL-PRS IUC request transmission from UE-B to UE-A, the same bit field size for the request in a SCI can be applied to MAC CE.
High layer signaling, such as PC5-S, PC5-RRC, application layer, and/or new higher layer (e.g., SL-LMF) can be used as the container of an explicit SL-PRS IUC request transmission from UE-B to UE-A.

The one or more parameters in the trigger signaling can include or be at least one of the following:
SL-data/SL-PRS IUC (e.g., SL-related data) indicator.
SL-PRS IUC option/implementation/arrangement/configuration/scheme indicator (e.g., coordination information scheme indicator).
Providing/requesting indicator.
SL resource pool index or SL-PRS resource pool index
Priority value to be used for SL-PRS transmission and/or for UE-B SL-data transmission.
Frequency location and/or number of sub-channels to be used for SL-PRS transmission (or UE-B SL-data transmission) in a slot.
Resource reservation interval for UE-B transmission.
Starting and/or ending time locations of UE-B resource selection window.
Resource set type/recommendation indication type, such as binary, non-binary, binary by region, and/or non-binary by region.
The UE ID information and/or distance/location information (e.g., destination ID, source ID, zone ID, communication range requirement, etc.).
Distance threshold, which can be one basis for determining whether the resource(s) is preferred.
SL-PRS sequence ID.
On-off indicator.
The number of measurement instance(s).
Automatic gain control (AGC)/gap symbol.
Cast type: at least one of unicast, groupcast, and/or broadcast. From certain implementations, several scenarios can be considered for sidelink positioning, such as V2X, public safety, commercial, and/or industrial internet of things (IIOT) use cases.
   Triggered by a Condition Other than Explicit Request

In some implementations, the SL-PRS IUC can be triggered by a condition other than the explicit request. For example, if SL-PRS IUC is triggered by a condition other than an explicit request, one or more of the parameters in trigger signaling can be (pre-) configured for a SL-PRS resource pool or resource pool. In some cases, if there is no (pre-) configuration, UE-A can determine the parameters by or according to its implementation/configuration.

### Triggered by Network

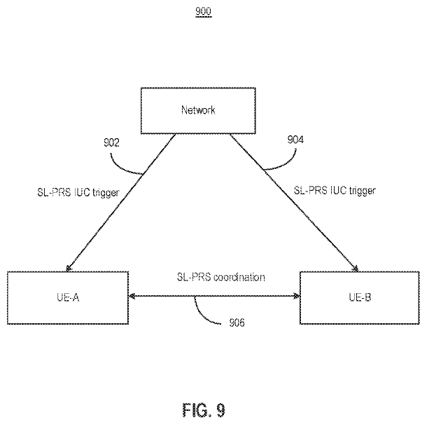

Referring to FIG. 9, depicted is a diagram 900 illustrating an example SL-PRS IUC scheme triggered by a network. For example, in various arrangements, the SL-PRS IUC can be triggered by the network (e.g., BS 102, gNB, and/or LMF). The network may assign a certain UE 104 to be the UE-B and at least one other UE 104 to be the UE-A. The network can send/transmit/provide/signal control signaling to UE-A (902). The network may assign UE-A to send SL-PRS IUC information to UE-B (e.g., SL-PRS coordination (906)). The network can inform UE-B about the UE-A (or several UEs 104) ID and/or assist/help the UE-B request SL-PRS IUC information from the UE-A (904). In some implementations, the network can send the control signaling to the UE-B (904) for coordination with the UE-A (e.g., UE-B sending the coordination information to the UE-A). The control signaling can include or correspond to at least one of: downlink control information (DCI), MAC CE, LPP signaling, and/or RRC.

The timing or when to trigger the SL-PRS IUC can be based on the respective configuration of the explicit request, at least one condition other than the explicit request, or the network. For example, the explicit request can consider at least one of the following for when to trigger:
According to or up to the configuration of the UE-B.
Up to the higher layer of the UE-B (e.g., at least one of MAC CE, PC5-S, PC5-RRC, application layer, and/or new higher layer, such as SL-LMF).
When UE-B has SL-PRS to be transmitted to UE-A.
When UE-B has SL-data to be transmitted to UE-A.
When UE-B has SL-PRS and/or SL-data (e.g., SL-related data) to be transmitted to UE-A.

For triggering based on or according to at least one condition other than the explicit request, at least one of the following can be considered:
Up to UE-A configuration/implementation.
Up to UE-A higher layer (e.g., at least one of MAC CE, PC5-S, PC5-RRC, application layer, and/or new higher layer, such as SL-LMF).
When UE-B has SL-PRS to be transmitted to UE-A.
When UE-B has SL-data to be transmitted to UE-A.
When UE-B has SL-PRS and/or SL-data to be transmitted to UE-A.

For triggering by the network, at least one of the following can be considered:
Up to network configuration/implementation.
When the network is configured or assigned to allocate SL-PRS and/or SL-data transmission.

### Implementation 3

In various arrangements (e.g., for arrangement 1), the timing relation for request triggered SL-PRS IUC transmission can be considered between the sensing window and/or selection window for the UE-B (e.g., for determining the set of resources) and the sensing window and/or selection window for UE-A used for sidelink transmission carrying SL-PRS inter-UE coordination information. The following indications can be used for or represent describing the timing relation of the sensing and/or selection window between the UE-A and the UE-B:
(n+T₁)—Start slot of resource selection window for determining the set of resources.
(n+T₂)—End slot of resource selection window for determining the set of resources.
(n′+T′₁)—Start slot of resource selection window used for sidelink transmission carrying SL-PRS inter-UE coordination information.
(n′+T′₂)—End slot of resource selection window used for sidelink transmission carrying SL-PRS inter-UE coordination information.
n′ can correspond to or represent the slot where UE procedure of determining TX (e.g., transmission) resources of sidelink transmission carrying SL-PRS inter-UE coordination information is triggered.
The sensing window for determining the set of resources can be defined/indicated/represented by the range of slots (e.g., resources), such as

$$[ ( n + {T}_{1} ) - {T}_{0} - {{T}^{′′}}_{1} , ( n + {T}_{1} ) - {T}_{proc , 0} - {{T}^{′′}}_{1} ] or [ ( n + {T}_{1} ) - {T}_{0} - {{T}^{′′}}_{1} , ( n + {T}_{1} ) - {T}_{proc , 0}^{SL - PRS} - {{T}^{′′}}_{1} ] ,$$

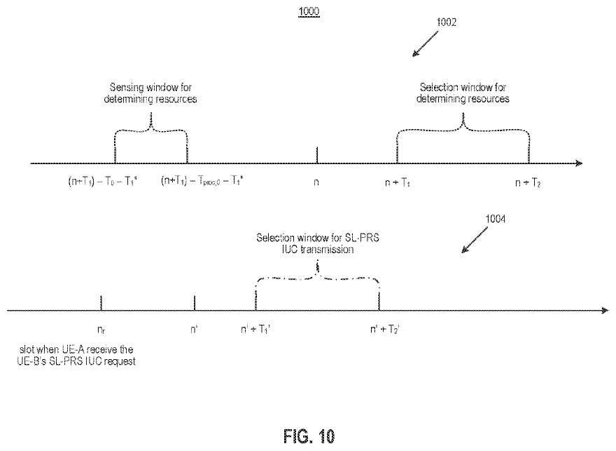

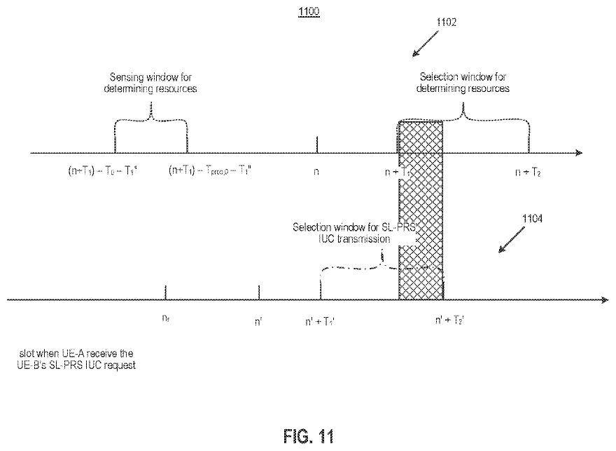

shown in conjunction with at least FIGS. 10-11. In some implementations, if the sensing window is used for SL-PRS transmission,

$${T}_{proc , 0}^{SL - PRS}$$

can be defined in slots and/or symbols, which can be related to the subcarrier spacing (SCS) configuration of the corresponding SL bandwidth parts (BWP) and/or a dedicated SL-PRS BWP. T₀ for SL-PRS can be defined in RRC layer and/or MAC layer, and/or by LMF and/or SL-LMF. The value range of T₀ can be larger/greater than or equal to SL-PRS resource reservation interval. The value range of T₀ can be different from T₀ in certain sidelink systems (e.g., legacy). In some cases, if the sensing window is used for SL-data transmission, T_{proc, 0} can be used instead of

$${T}_{proc , 0}^{SL - PRS} .$$

If the selection window is used for SL-PRS transmission:
   Selection of T₁ and T′₁ can be up to the UE 104 configuration/implementation under

$$0 \leq {T}_{1}^{} / {T}_{1}^{′} \leq {T}_{proc , 1}^{SL - PRS} \cdot {T}_{proc , 1}^{SL - PRS}$$

can be defined in one or more slots and/or symbols, and/or can be related to the SCS configuration of the corresponding SL BWP and/or a dedicated SL-PRS BWP.
T₂ₘᵢₙ^{SL-PRS} can be related to the SCS configuration of the corresponding SL BWP and/or a dedicated SL-PRS BWP. If

$${T}_{2 min}^{SL - PRS}$$

is shorter/less than the remaining packet delay budget (e.g., in slots or symbols), (e.g., selection/determination of) T₂ and/or T′₂ can be up to the UE 104 configuration under

$$0 \leq {T}_{2} / {T}_{2}^{′} \leq {T}_{2 min}^{SL - PRS} .$$

Otherwise, T₂ and T′₂ can be set/configured to the remaining packet delay budget (e.g., in slots or symbols). The remaining packet delay budget can depend on or be in accordance with the sidelink transmission type, such as SL-data and/or SL-PRS.
If the selection window is used for SL-data transmission, the set of T₁, T′₁, T₂, and/or T′₂ can reuse a certain sidelink configuration (e.g., legacy sidelink configuration).

The sensing window size W of the UE-A used for sidelink transmission carrying SL-PRS inter-UE coordination information can be larger/greater than or equal to the resource reservation interval for UE-B transmission (e.g., SL-PRS transmission and/or SL-data transmission).

For request triggered SL-PRS IUC transmission:
nᵣ: slot when UE-A receives SL-PRS IUC request information of the UE-B.

$$\cdot X 1 \leq ( {n}^{′} + {T}_{1}^{′} ) .$$

$$\cdot ( {n}^{′} + {T}_{2}^{′} ) \leq X 2.$$

At least one of the implementations/configurations/options can be applied to define/indicate the value range of X1 and X2. As discussed herein, four configurations can be applied to define the value range of X1 and X2, although other configurations can be applied in similar manners.

### Configuration 1

As a first configuration, X1 and X2 can be (pre-) defined/configured by the network and/or the UE 104, such as in RRC layer and/or MAC layer, and/or by LMF and/or SL-LMF, and/or PC5-RRC layer, PC5-S layer, among others.

### Configuration 2

Referring to FIG. 10, depicted is a plot 1000 illustrating an example of non-overlapping between the selection window for SL-PRS IUC transmission and the selection window for determining resources. In various implementations, there may be no overlapping between the sensing and/or selection windows of the UE-B (e.g., for determining the set of resources) and the sensing and/or selection windows of the UE-A (e.g., used for sidelink transmission carrying SL-PRS inter-UE coordination information).

The starting point of the selection window for SL-PRS IUC transmission (e.g., shown in plot 1004) can be set or assigned after the slot when the UE-A receives SL-PRS IUC request information from the UE-B (e.g., shown in plot 1002). The ending point of the selection window for SL-PRS IUC transmission can be set before the slot when the selection window for determining resources of the UE-B starts (e.g., shown in plot 1002). The time delay for UE decoding can be considered or accounted for. As shown in conjunction with FIG. 10, [nᵣ+T_proc+T′₁]≤[(n′+T′₁)] and [(n′+T′₂)]≤[n+T₁−T_{proc}]. The T_{proc} can be defined in the slots and/or symbols, which can be related to the SCS configuration of the corresponding SL BWP and/or a dedicated SL-PRS BWP.

### Configuration 3

Referring to FIG. 11, depicted is a plot 1100 illustrating an example of partial-overlapping between the selection window for SL-PRS IUC transmission and the selection window for determining resources. In various implementations, overlapping (e.g., partial overlapping) may occur or be presented between the sensing/selection window of the UE-B (e.g., for determining the set of resources) and sensing/selection window of the UE-A (e/g., used for sidelink transmission carrying SL-PRS inter-UE coordination information).

Overlapping can be allowed, such as in various cases when the number of candidate single-slot resources remaining in the selection window is larger than X·Mₜₒₜₐₗ, for example. For example, the overlapping of the selection windows between the UE-A and UE-B can be shown between plots 1102 and 1104. Mₜₒₜₐₗ can correspond to or represent the total number of candidate single-slot resources. X can indicate the portion of candidate single-slot SL-PRS resources over the total resources (e.g., if UE-B is configured to transmit SL-PRS). X can be (pre-) defined/configured in RRC layer, MAC layer, by LMF, and/or SL-LMF, among others. X can correspond to the transmission priority of the UE-B, for example,

$${prio}_{TX}^{SL - PRS}$$

for SL-data transmission and/or prio_{TX}^{SL} for SL-data transmission.

An example for RRC configuration can be provided as follows:

```
SL-TxPercentageList-r16 ::= SEQUENCE (SIZE (8)) OF
SL-TxPercentageConfig-r16
SL-TxPercentageConfig-r16 ::= SEQUENCE {
  sl-Priority-r16 INTEGER (1..8),
  sl-TxPercentage-r16 ENUMERATED {p20, p35, p50}
}
SL-PRS-TxPercentageList ::= SEQUENCE (SIZE (N)) OF SL-PRS-
TxPercentageConfig
SL-PRS-TxPercentageConfig ::= SEQUENCE {
  Sl-PRS-Priority INTEGER (1..n_prsprio),--can be non-integer
  Sl-PRS-TxPercentage ENUMERATED {pn1, .., pnn} --pn1 means
n1%, pnn means nn%
}
```

### Configuration 4

The timeline of the selection window for SL-PRS IUC transmission can be up to or in accordance with UE-A configuration/implementation. The UE-B can determine/choose not to use the resource from the preferred and/or non-preferred resource set in during the resource selection (or reselection) process, for example, if the resource is earlier than a time delay (e.g., T_{proc}, 0+T_{proc}, 1+T_{proc,2}, and/or

$${T}_{proc , 0}^{SL - PRS} + {T}_{proc , 1}^{SL - PRS} + {T}_{proc , 2}^{SL - PRS} ,$$

among others) after the resource of inter-UE coordination information transmission. The time delay can correspond to the utilized request trigger signaling (e.g., SCI, MAC CE, PC5-RRC, PC5-S, and/or SL-LPP, etc.).

The latency bound of SL-PRS inter-UE coordination report from the associated SL-PRS inter-UE coordination explicit request triggering (e.g., sometimes referred to as sl-prs-LatencyBoundIUC-Report) may be (pre-) defined/configured by the network, the UE 104 in RRC layer and/or MAC layer, by the LMF and/or SL-LMF, PC5-RRC layer, and/or PC5-S layer, among others.

### Implementation 4

In various aspects (e.g., for arrangement 1), the container of SL-PRS IUC report from UE-A to UE-B can include or correspond to at least one of the following:
MAC CE can be used as the container of SL-PRS IUC information transmission from UE-A to UE-B.
SCI can be used as the container of SL-PRS IUC information transmission from UE-A to UE-B.
   For example, the SCI can include at least one exclusive second stage SCI format for SL-PRS IUC information requests and/or reports.
      Dedicated SL-PRS pool with control signaling SL-PRS SCI.
      Shared resource pool with SL communication. Introducing a new second stage SCI format.
   In another example, SCI 2-C can be used. The field “SL-data/SL-PRS IUC indicator” can be added.
      Four cases: SL-data IUC request, SL-data IUC report, SL-PRS IUC request, and/or SL-PRS IUC report.
      For each case, one or more corresponding fields in SCI 2-C can be activated and one or more other irrelevant fields in SCI 2-C may be disabled.
In some cases, when both MAC CE and SCI are used as the container of SL-PRS IUC information transmission from UE-A to UE-B, the same bit field size for the report in the SCI can be applied to the MAC CE.
High layer signaling (e.g., PC5-RRC, PC5-S, application layer, and/or new higher layer, such as SL-LMF) can be used as the container of SL-PRS IUC information transmission from UE-A to UE-B.

SL-PRS IUC report can include at least one of the following information:
SL-data/SL-PRS IUC indicator (e.g., if SCI 2-C are reused).
Providing/requesting indicator.
Resource pool index or SL-PRS resource pool index.
A coordination information scheme indicator.
Priority value to be used for conflict transmission of other UEs 104 detected by UE-A.
Reference resource location.
First resource location.
Frequency location or lowest subchannel indices.
The number of sub-channels to be used for SL-PRS transmission (e.g., may or may not be included for UE-B SL-data transmission) in a slot.
Resource reservation interval for UE-B transmission.
Starting or ending time locations/positions of UE-B resource selection window.
Resource set type: recommendation level (e.g., binary, non-binary, binary by region, and/or non-binary by region).
The association relationship(s) between the recommendation level and the time-frequency region (e.g., if the resource set type is binary by region and/or non-binary by region).
The association relationship(s) between resource pool index and/or SL-PRS resource pool index and time-frequency region (e.g., if the resource set type is binary by region and/or non-binary by region).
SL-PRS sequence ID.
On-off indicator.
Number of measurement instance.
AGC/gap symbol.
Cast type: unicast, groupcast, and/or broadcast.
The UE ID information and/or distance/location information (e.g., destination ID, source ID, zone ID, communication range requirement, etc.) of UE-A and one or more other UEs 104 (e.g., whose transmission may conflict with UE-B).
The distance between UE-B and one or more other UEs 104 and/or distance between UE-A and the other UE(s) 104.

In various implementations, the transmission resource can be selected or reselected. For binary resource recommendation (e.g., for the whole selection window or a portion/regional):
For preferred resource set:
   In some cases, the (re-) selection can be based on the sensing result (e.g., if available) and the received coordination information of the UE-B.
   In some other cases, the (re-) selection can be based on the received coordination information (e.g., without the sensing result).
For non-preferred resource set:
   In various implementations, the (re-) selection can be based on the sensing result (e.g., if available) and/or the received coordination information of the UE-B. In the resource (re-) selection of the UE-B, the UE-B can exclude the resource(s) overlapping with the non-preferred resource set.

For non-binary resource recommendation (e.g., for the whole selection window or partial/regional):
A recommendation level threshold can be (pre-) configured for UE-B. For example, when UE-B receives the recommendation level which is higher/greater than the threshold, UE-B can treat/associate/consider the corresponding resource(s) as preferred. Otherwise, UE-B can consider the corresponding resource(s) as non-preferred.
The recommendation level threshold can be (pre-) configured on at least one of: MAC layer, PC5-RRC, PC5-S, RRC layer, application layer, and/or new higher layer (e.g., LMF in legacy positioning protocol, such as SL-LMF).

### Implementation 5

In various implementations (e.g., for arrangement 2), SL-PRS IUC information sent from UE-A to UE-B can include the presence of expected, potential, and/or detected resource conflict at least on the resources which have been indicated or reserved by the UE-B. UE-A can consider/determine that a resource conflict occurs on a first reserved resource and/or multiple/several reserved resources indicated by a received SCI from UE-B, for example, if at least one of the following conditions/parameters/criteria is satisfied/met:
The reserved resource(s) indicated by a received SCI from UE-B overlaps with at least one other reserved resource indicated by another received SCI from at least one other UE 104:
   When the RSRP measurement is greater than the threshold, for example, corresponding to whether UE-A is a destination UE 104 for UE-B or a destination UE 104 for at least one other UE 104:
      Relative RSRP threshold for SL-PRS:
         If the priority of SL-PRS is indicated in SCI (e.g., including at least one of the first stage SCI and/or the second stage SCI and/or SL-PRS SCI), the threshold can be selected based on the priority in the decoded SCI. Subsequently, the priority in the SCI can be transmitted. The priority of SL-PRS may also be (pre-) configured by the network (e.g., BS 102 and/or LMF) and/or the higher layer of the UE 104.
         The RSRP threshold can be configured on at least one of MAC layer, RRC layer, PC5-S, application layer, and/or new higher layer, such as SL-LMF, among others.
      Configured/Pre-configured RSRP threshold for SL-PRS:
         SL-PRS-RSRP1−SL-PRS-RSRP2 and/or SL-PRS-RSRP2−SL-PRS-RSRP1 and/or |SL-PRS-RSRP1−SL-PRS-RSRP2| (e.g., absolute value) can be greater than the (pre-) configured RSRP threshold.
         The (pre-) configured RSRP threshold can be configured on at least one of the MAC layer, RRC layer, PC5-S, application layer, and/or new higher layer, such as SL-LMF.
   The reserved resource(s) of UE-B with a priority value larger/greater than the priority of one or more other UEs 104 identified by UE-A (e.g., if provided). For example, the transmission of one or more other UEs 104 can take precedence or be prioritized over UE-B transmission in this case.
   In various implementations, if the (e.g., general) location is provided, UE-A may consider reporting the conflict information when at least one other UE 104 is within proximity (e.g., not too far away or the distance to the other UE 104 is within a threshold/range) from UE-B. For example, the distance between UE-B and another UE 104 is less than (or equal to) a distance threshold. The range ambiguity may be reported. The distance threshold can be configured on at least one of the MAC layer, RRC layer, application layer, and/or new higher layer (e.g., SL-LMF, etc.).
The reserved resource(s) can occur in a slot in which UE-A may not be expected to perform SL-PRS and/or SL reception due to half-duplex operation.

SL-PRS IUC may contain/include an indication of one or more expected, potential, and/or detected resource conflicts. The container of conflict reserved resource(s) (e.g., SL-PRS IUC) reported from UE-A to UE-B can correspond to or include at least one of the following:
PSFCH can be used as the container of conflict reserved resource(s) (SL-PRS IUC) report from UE-A to UE-B.
MAC CE can be used as the container of conflict reserved resource(s) (SL-PRS IUC) report from UE-A to UE-B.
SCI can be used as the container of conflict reserved resource(s) (SL-PRS IUC) report from UE-A to UE-B.
   For example, at least one exclusive second stage SCI format can be used for SL-PRS IUC information requests and/or reports.
      Dedicated SL-PRS pool with control signaling SL-PRS SCI.
      Shared resource pool with SL communication. Introducing a new second stage SCI format.
   SCI 2-C with an added field “SL-data/SL-PRS IUC indicator” can be used.
      Four cases: SL-data IUC request, SL-data IUC report, SL-PRS IUC request, and/or SL-PRS IUC report.
      For each case, the corresponding fields in SCI 2-C can be activated and/or at least one other irrelevant field in SCI 2-C may be disabled.
      SL-PRS IUC scheme type indication if various implementations/configurations of SL-PRS IUC (e.g., arrangements 1 and/or 2, among others) use SCI as the container, for example, the configuration for resource recommendation and/or the configuration for the reserved resource(s) conflict information.
When both MAC CE and SCI are used as the container of conflict reserved resource(s) (e.g., SL-PRS IUC) report from UE-A to UE-B, the same bit field size in the SCI can be applied to MAC CE.
High layer signaling (e.g., PC5-RRC, PC5-S, application layer, and/or new higher layer, such as SL-LMF) can be used as the container of conflict reserved resource(s) report from UE-A to UE-B.

In various implementations, if UE-A determines a conflict for a reserved resource for SL-PRS transmission, UE-A can provide conflict information in a PSFCH. In some arrangements, if SL-PRS is configured in a shared resource pool with SL communication, the priority of PSFCH can be considered according to or based on at least one of the following aspect (e.g., PSFCH transmission can include/contain HARQ-ACK (hybrid automatic retransmission request-acknowledgement) information, SL-data conflict information, and/or SL-PRS conflict information):
Priority value of PSFCH TX for a SL-PRS resource conflict indication: the smallest priority value of the conflicting TBs.
Priority value of PSFCH RX for a SL-PRS resource conflict indication: priority value SL-PRS indicated by SCI of UE-B.
Priority value of PSFCH TX for a SL-data resource conflict indication.
Priority value of PSFCH RX for a SL-data resource conflict indication.
PSFCH TX/RX for SL HARQ-ACK feedback.

The prioritization between different PSFCH transmission types can be at least one of the following:
PSFCH transmission (TX)/reception (RX) for SL HARQ-ACK feedback can be prioritized over PSFCH TX/RX for SL-data resource conflict indication and/or SL-PRS resource conflict indication.
   In some cases, PSFCH TX/RX for a SL-data resource conflict indication can be prioritized over SL-PRS resource conflict indication.
   In some cases, PSFCH TX/RX for SL-PRS resource conflict indication can be prioritized over SL-data resource conflict indication.
PSFCH TX/RX for SL-PRS resource conflict indication can be prioritized over PSFCH TX/RX for a SL-data resource conflict indication and/or SL HARQ-ACK feedback.
   PSFCH TX/RX for SL HARQ-ACK feedback can be prioritized over SL-data resource conflict indication.

PSFCH for SL-PRS IUC can be used to indicate one or more expected, potential, and/or detected resource conflicts.
For one expected, potential, and/or detected resource conflict indication: the design PSFCH for SL-PRS IUC to covey the 1-bit information can be considered. PSFCH can be configured in the SL data resource pool and/or dedicated resource pool for SL-PRS.
For several/multiple expected, potential, and/or detected resource conflict indications: redesign slot structure for PSFCH in SL data resource pool, for example, if SL-PRS and/or SL-data share the same pool, and/or design the new slot structure in dedicated SL-PRS resource pool.
   PSFCH may be designed to occupy one or more OFDM symbols.
   PSFCH may be designed to occupy one or more PRBs.
   PSFCH sequence for capacity enhancement considering at least one of: the association relationships between conflict indication and sequence cyclic shift, increasing the maximum number of cyclic shifts.

In various implementations, if SL-PRS is configured in a dedicated resource pool, for each SL-PRS slot structure, a gap symbol in the last symbol of a slot can be utilized/configured for Rx/Tx switch and/or one AGC symbol in the first symbol of a slot can be configured to assist AGC training.

For each SL-PRS slot structure, PSCCH may be configured to carry the first stage SL-PRS SCI and/or to carry SL-PRS SCI based on/depending on/according to the SCI design/configuration for SL-PRS. PSCCH can be configured within a frequency band range and/or the lowest frequency range/sub-channel/PRBs for SL-PRS transmission. The frequency range of PSCCH may be the same as SL-PRS. The number of PRBs that PSCCH occupy may not vary with the frequency domain size of SL-PRS.

PSCCH may occupy non-overlapping OFDM symbols with SL-PRS. Additionally or alternatively, PSCCH may share OFDM symbols with SL-PRS. Depending on whether a resource pool for SL-PRS is configured with PSFCH, for example, if configured, one gap symbol for Rx/Tx switch and/or one AGC symbol for power adjustment can be configured before the PSFCH symbol. In comparison to SL-PRS, the transmit power and power control of PSFCH may be different. The AGC symbol can be a repetition of the PSFCH symbol.

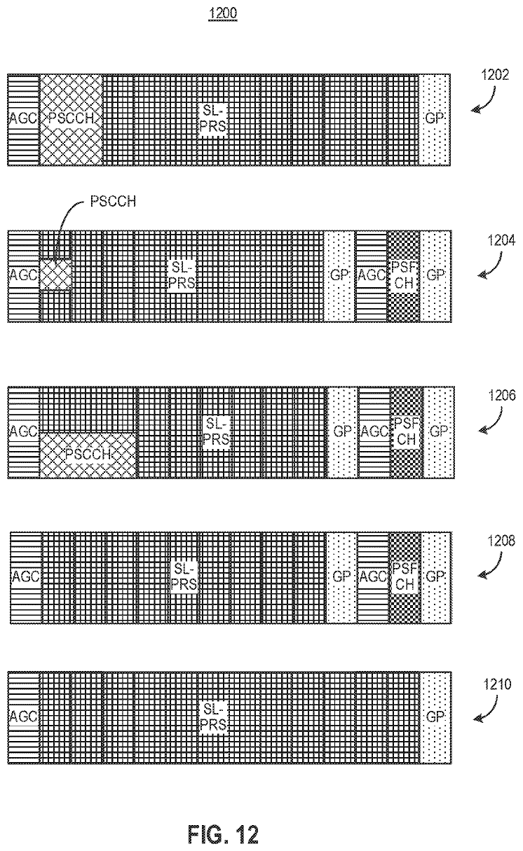

Examples of the slot structure in a dedicated SL-PRS resource pool can be shown in conjunction with FIG. 12. Referring to FIG. 12, examples 1200 of slot structures in a dedicated SL-PRS resource pool are depicted. For example, slot structures 1202 and 1210 can be in a dedicated SL-PRS resource pool without PSFCH configuration. In another example, slot structures 1204-1208 can be in a dedicated SL-PRS resource pool with PSFCH configuration.

To determine the PSFCH occasion/occurence for SL-PRS IUC information, at least one of the following configurations/options/implementations can be considered:
Configuration 1: PSFCH occasion can be derived by a slot where SCI of UE-B is transmitted.
Configuration 2: PSFCH occasion can be derived by a slot where expected/potential resource conflict occurs on SL-PRS resource indicated by SCI of UE-B.

The UE 104 (e.g., UE-A) can transmit/send/provide the PSFCH in a first slot that includes PSFCH resources and/or is at least a certain number of slots (e.g., sl-PRS-MinTimeGapPSFCH can be provided by higher layer PC5-RRC, PC5-S, application layer, and/or new higher layer, such as SL-LMF, RRC, MAC layer, etc.) after an SL-PRS reception. The PSFCH resource can be in a slot that is at least

$${T}_{3}^{SL - PRS}$$

slots (e.g.,

$${T}_{3}^{SL - PRS}$$

is equal to

$${T}_{proc , 1}^{SL - PRS}$$

and/or related to SCS configuration) before the resources associated with the conflict information. Otherwise, in some cases, UE-A may not transmit the PSFCH with SL-PRS conflict information.

UE-A may consider or account for a resource conflict that occurs on N (e.g., a certain number of) reserved resources indicated by a received SCI from UE-B. Various implementations/arrangements discussed herein can be considered.

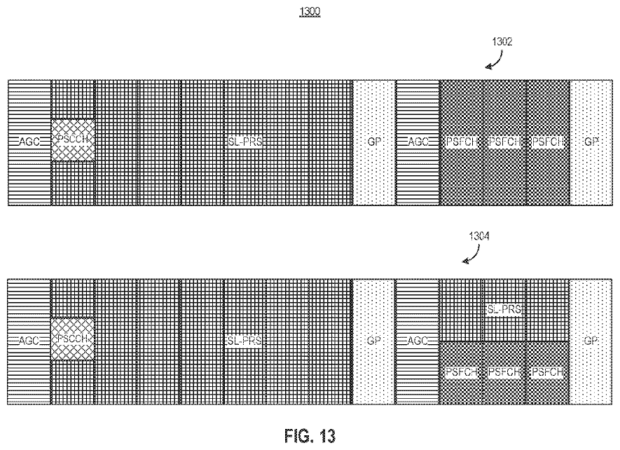

In certain arrangements, referring to FIG. 13, depicted are examples 1300 of slot structures in a dedicated SL-PRS resource pool with PSFCH occupying more than one symbol. For example, if SL-PRS is configured in a dedicated resource pool, additional/more symbols/N symbols per slot for PSFCH can be applied. In this case, as shown in slot structures 1302 and 1304, PSFCH can occupy more than one symbol. Both TDM and FDM between PSFCH and SL-PRS can be considered.

To determine the PSFCH occasion for SL-PRS IUC information, at least one of the following configurations can be considered:
Configuration 1: PSFCH occasion can be derived by a slot where UE-B SCI is transmitted/sent/provided.
Configuration 2: PSFCH occasion can be derived by a slot where the first expected/potential resource conflict occurs on SL-PRS resource indicated by SCI of UE-B.
Configuration 3: PSFCH occasion can be derived by a slot where the last expected/potential resource conflict occurs on SL-PRS resource indicated by SCI of UE-B.
Configuration 4: PSFCH occasion can be derived by a slot considering all the expected/potential resource conflict that occurs on SL-PRS resource indicated by SCI of UE-B.

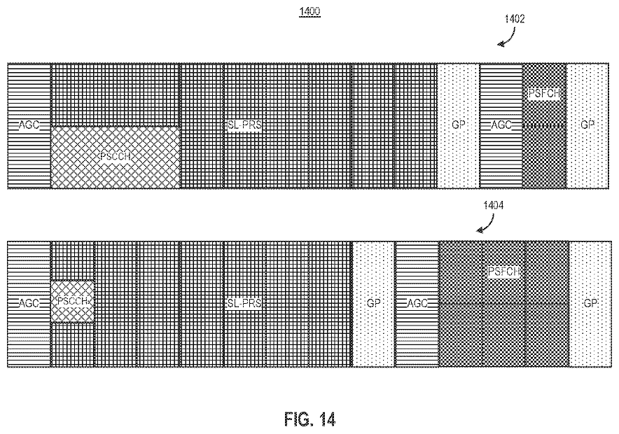

In some arrangements, referring to FIG. 14, depicted are examples 1400 of slot structures in a dedicated SL-PRS resource pool with more than one PSFCH occupying the frequency domain. For several (e.g., N or a number of) resource conflicts indication, multi-PSFCH in the frequency domain can be considered. As shown in slot structures 1402 and 1404:
PSFCH can occupy/situate one RB (resource block) in the frequency domain (e.g., slot structure 1402).
PSFCH can occupy more than one RB in the frequency domain (e.g., slot structure 1404).
Two or more PSFCH can be simultaneously transmitted and/or received on one symbol (e.g., slot structures 1402 and 1404).

In further arrangements, PSFCH sequence design can be used or leveraged for one or more (e.g., N number of) resource conflict indications. The sequence design of PSFCH can include/contain sequence generation and/or cyclic shift. One PSFCH sequence may carry/include/contain more than one bit of conflict information. Multiple PSFCH sequences can be defined from a single base sequence through one or more different cyclic shifts and sequence hopping. An example of the PSFCH sequence design can be provided as follows:

The sequence x(n) shall be generated according to

$$x ( n ) = {r}_{u , v}^{( α , δ )} ( n ) and n , 0 , 1 , … , {N}_{sc}^{RB} - 1 ,$$

where

$${r}_{u , v}^{( α , δ )} ( n )$$

may be predetermined based on the specification or standards, such as with the following exceptions:
m_{cs} can be given by a certain clause;
m₀ can be given by the certain clause;
l=0;
l′ can be the index of the OFDM symbol in the slot that corresponds to the second OFDM symbol of the PSFCH transmission in the slot, such as given by the clause;
u=n_{ID} mod 30 and v=0 with nip can be given by the higher-layer parameter s/-PSFCH-HopID (e.g., if configured); Otherwise, u=0.
cᵢₙᵢₜ=n_{ID} with n_{ID} can be given by the higher-layer parameter sl-PSFCH-HopID (e.g., if configured); Otherwise, cᵢₙᵢₜ=0.

$$δ = 0$$

$${r}_{u , v}^{( α , δ )} ( n ) = {e}^{j α n} {\overline{r}}_{u , v} ( n ) , 0 \leq n < {M}_{ZC}$$

$${α}_{l} = \frac{2 π}{{N}_{sc}^{RB}} ( ( {m}_{0} + {m}_{cs} + {m}_{int} + {n}_{cs} ( {n}_{s , f}^{μ} , l + {l}^{′} ) ) mod {N}_{sc}^{RB} )$$

α can be the cyclic shift

If the sequence length remains up to 12: n=0, 1, . . . ,

$${N}_{sc}^{RB} - 1 ,$$

the bits PSFCH can contained/included can be {1, 2, 3}. Each conflict indication can correspond to at least one specific sequence cyclic shift. There may be one or more association relationships between conflict indication and sequence cyclic shift. Examples of certain association relationships can be provided as follows (e.g., other sequence cyclic shifts may not be precluded):

| Conflict | | |
|---|---|---|
| indication | 0 | 1 |
| Sequence | m_{cs} = 0 | m_{cs} = 6 |
| cyclic | | |
| shift | | |

| Conflict | | | | |
|---|---|---|---|---|
| indication | {0, 0} | {0, 1} | {1, 1} | {1, 0} |
| Sequence | m_{cs} = 0 | m_{cs} = 3 | m_{cs} = 6 | m_{cs} = 9 |
| cyclic | | | | |
| shift | | | | |

| Conflict | | | | | | | | |
|---|---|---|---|---|---|---|---|---|
| indication | {0, 0, 0} | {0, 0, 1} | {0, 1, 1} | {0, 1, 0} | {1, 0, 0} | {1, 0, 1} | {1, 1, 1} | {1, 1, 0} |
| Sequence | m_{cs} = 0 | m_{cs} = 1 | m_{cs} = 2 | m_{cs} = 4 | m_{cs} = 6 | m_{cs} = 8 | m_{cs} = 10 | m_{cs} = 11 |
| cyclic shift | | | | | | | | |

The maximum number of bit one PSFCH can be enlarged, for example, by increasing PSFCH sequence length and/or increasing the base of the remainder for cyclic shift parameter. For example, if UE-A indicates the conflict information for four reserved resources of UE-B, cyclic shift 1 can correspond to 0000, which can indicate that no conflicts are detected, and cyclic shift 2 can correspond to 1000, which can indicate that one conflict is detected in the first reserved resource. Additionally (or alternatively) to PSFCH, the container of SL-PRS IUC (e.g., of a certain arrangement) conflict information can correspond to or be at least one of: PSFCH, MAC CE, SCI, RRC, PC5-RRC, PC5-S, LMF (e.g., LPP signaling), SL-LMF (e.g., SL-LPP signaling), among others.

### Implementation 6

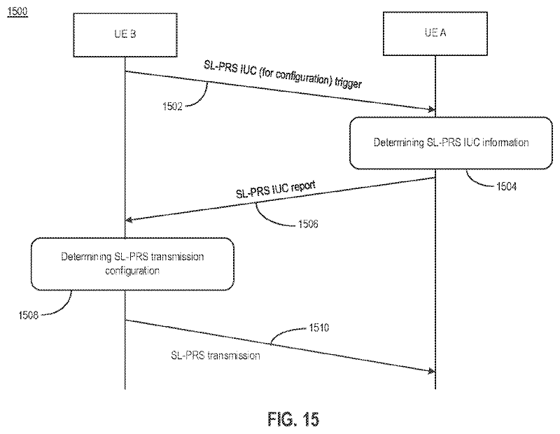

In various arrangements (e.g., for arrangement 3), the SL-PRS IUC information sent from UE-A to UE-B can include one or more recommendations for SL-PRS configurations/characteristics of UE-B. Referring to FIG. 15, depicted is a flow diagram illustrating an example method 1500 or procedure for an SL-PRS IUC information including SL-PRS configurations or characteristics. The example method 1500 can include at least the following:
If UE-B requests IUC for SL-PRS configuration recommendation, the higher layer of the UE 104 (e.g., SL-LMF, PC5-RRC, PC5-S, application layer, etc.) may configure the UE 104 with pre-defined/configured/predetermined SL-PRS configuration(s) via a higher layer signaling (e.g., SL LPP).
The UE 104 (e.g., UE-B) can report SL-PRS IUC capability and/or SL-PRS positioning capability (e.g., via SL LPP to SL-LMF, application layer, PC5-RRC, and/or PC5-S, among others).
UE-B can send an SL-PRS configuration IUC request, such as a request for a pre-defined SL-PRS configuration indicated with a pre-defined SL-PRS configuration ID and/or explicit parameter for SL-PRS configuration (1502). In some cases, the SL-PRS configuration IUC request may be a request for SL-PRS transmission and/or a change to the SL-PRS transmission characteristics for positioning measurements.
UE-A can identify the request for (e.g., determine that another UE 104, such as UE-B requests for) IUC information (e.g., coordination information). For example, the UE-A can determine SL-PRS IUC information (1504). The UE 104 can provide the IUC information for UE-B SL-PRS configuration (1506).
UE-B can determine or identify the SL-PRS transmission configuration (1508). Accordingly, the UE-B can perform SL-PRS transmission based on the IUC information (e.g., transmit SL-PRS) (1510). In some cases, the UE-A may be the destination UE 104 of the UE-B SL-PRS transmission. In some other cases, the UE-A may not be the destination UE 104 of this transmission.

In some implementations, UE-B may request the granularity of the SL-PRS configuration recommendation. The request signaling can include at least one of the following parameters:
Priority value, frequency location, resource reservation interval, starting and/or ending time locations of resource selection window, resource set type (e.g., recommendation level), among others.
SL-PRS configuration parameters: periodicity, resource bandwidth, repetition factor, SL-PRS muting pattern, SL-PRS comb size, number of SL-PRS resource symbols, QCL (Quasi Co-Location) information, start/end time of SL-PRS transmission, range of SL-PRS MCS (modulation and coding scheme) value, range of the number of SL-PRS sub-channels, maximum SL-PRS (re) transmission number, SL-PRS MaxTxPower (maximum transmission power), SL-PRS CRₗᵢₘᵢₜ (channel occupancy ratio), SL-PRS resource set ID, SL-PRS resource ID, SL-PRS AGC symbol and gap symbol, and/or cyclic prefix length of SL-PRS resource, among others.

UE-A can report at least one of the following IUC information for SL-PRS configurations/characteristics of the UE-B (e.g., granularity):
The preferred and/or non-preferred SL-PRS configurations to UE-B (e.g., binary).
A certain recommendation level for different SL-PRS configurations can be reported (e.g., non-binary).
The preference (e.g., binary and/or non-binary) indicated in IUC information can be associated with the SL-PRS configuration(s).
The preference (e.g., binary or non-binary) indicated in IUC information can be associated with at least one or a subset of the SL-PRS configurations.
   Different preferences can be associated with different SL-PRS configurations/characteristics parameters.
   Different preferences can be associated with different values of at least one SL-PRS configuration/characteristic parameter.
   For each configuration parameter, preferred, non-preferred, and/or other levels of preference can be attached or associated.
In various aspects, the configuration parameters can be related to the conflict information. For example, if UE-A detects a resource conflict, UE-A can inform/notify UE-B to use a larger/longer periodicity to transmit one or more resources.

To define UE-A in a certain arrangement of SL-PRS IUC, some configurations can be considered, such as the following:
The network (e.g., LMF and/or BS 102) can assign one or more UEs 104 to be UE-A.
(Pre-) configuration can be supported to enable or disable whether the UE 104 can be the UE-A of SL-PRS IUC (e.g., receptor of the coordination information or SL-related data) (or not).
The UE 104 with the capability to be UE-A can send a request to the network.
The UE 104 can report the corresponding capability.
Some restrictions/limitations/confinements can be provided/indicated/implemented, for example, mobility UE 104 may not be considered. In some cases, RSU can be treated as UE-A, etc.

### Implementation 7

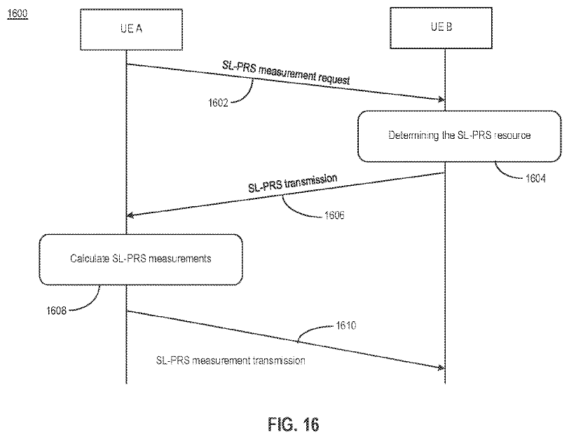

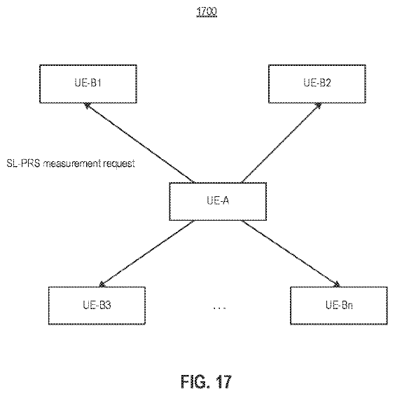

In various arrangements (e.g., for arrangement 4), the SL-PRS IUC transfer framework can be used/reused for at least one measurement request and/or report. Referring to FIG. 16, depicted is a flow diagram illustrating an example method 1600 or procedure for reusing an SL-PRS IUC transfer framework for measurement request and/or report. In conjunction with FIG. 16, FIG. 17 illustrates an example 1700 of requesting and/or reporting SL-PRS measurement.

The SL-PRS measurement request and report procedures, such as in the example method 1600, can include at least the following:
In some implementations, SL-PRS measurement request can be sent from the UE-A to one or more UE-Bs (1602). The request signaling can be unicast, groupcast, and/or broadcast. SL-PRS measurement request may be sent along with SL-PRS IUC report and/or SL-PRS IUC request from UE-A to one or more UE-Bs. In some cases, the SL-PRS measurement request can be a measurement request signaling. SL-PRS measurement request may include/contain the time domain behavior of the measurement report (e.g., time stamp(s), quality metric(s), ID(s), etc.) and/or one or more contents of the measurement report (e.g., angular/timing/power measurements).
UE-B can determine the SL-PRS resource (1604). The SL-PRS configuration can be (pre-) configured by the higher layer, by the network, and/or by one or more other UEs 104.
SL-PRS transmission by the UE-B(s) (1606).
UE-A can calculate SL-PRS measurement(s) (1608). Accordingly, UE-A can send the measurement(s) to UE-B(s) (1610). The SL-PRS measurement can include/report at least one of the following information: the association of UE Tx TEG ID and SL-PRS, PCI, GCI, SL-PRS ID, ARFCN, SL-PRS resource ID, SL-PRS resource set ID for each measurement, SL-PRS RSRP measurement, UE Rx-Tx time difference measurement, time stamp of the measurement, time stamp of location estimate, quality of each measurement, timing advance (TA) offset used by at least one of UE 104, UE Rx TEG IDs, UE Tx TEG IDs, and/or UE RxTx TEG IDs associated with UE Rx-Tx time difference measurements, line-of-sight (LOS)/non-line-of-sight (NLOS) information for UE measurements, latitude/longitude/altitude, e.g., together with uncertainty shape, SL-PRS receive beam index, and/or SL-PRS RSRPP (reference signal received path power) measurement, among others.
In various implementations, the signaling for SL-PRS measurement request and/or report can be at least one of the following: physical layer (e.g., SCI), MAC layer, RRC layer, PC5-RRC, PC5-S, application layer, and/or new higher layer, such as SL-LMF.

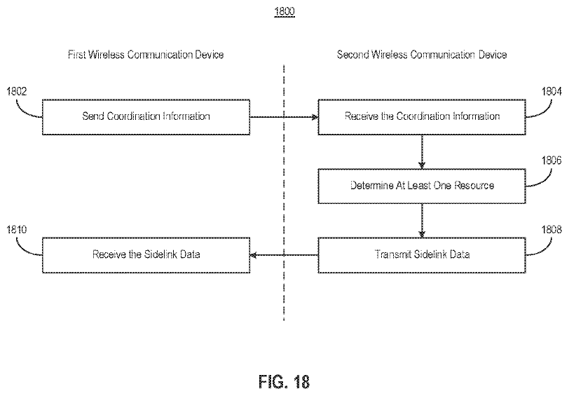

FIG. 18 is a flow diagram illustrating an example method 1800 for managing SL communications. Referring to FIG. 18, the method 1800 can be performed by the BS 102, a first UE (e.g., the relay UE, the TX UE, or the UE 104a), and a second UE (e.g., the remote UE, the RX UE, or the UE 104b), among other devices. In some arrangements, at 1802, the first wireless communication device (e.g., the first UE) can send/transmit/provide/signal coordination information to one or more UEs (e.g., the second wireless communication device). At 1804, the second wireless communication device (e.g., the second UE) can receive the coordination information from the first wireless communication device. At 1806, the second wireless communication device can determine at least one resource. At 1808, the second wireless communication device can transmit sidelink data to at least one other wireless communication device (e.g., the first wireless communication device). At 1810, the first wireless communication device can receive the sidelink data from the second wireless communication device.

In further detail, at 1802, the first wireless communication device (e.g., UE-A) can send/transmit/provide coordination information (e.g, IUC information) to the second wireless communication device (e.g., UE-B). The coordination information can be utilized for coordinating sidelink positioning among one or more wireless communication devices, such as the second wireless communication device.

At 1804, the second wireless communication device can receive the coordination information from the first wireless communication device for sidelink positioning among one or more wireless communication devices. At 1806, the second wireless communication device can determine, by the second wireless communication device, at least one resource for transmitting sidelink-related data. The sidelink-related data can include at least one of sidelink positioning reference signaling (e.g., SL data or PSSCH) or sidelink data (e.g., SL-PRS).

In various arrangements, the coordination information can be determined by the first wireless communication device (e.g., binary). For example, the first wireless communication device can recognize at least one resource as favored (e.g., preferred or recommended) or disfavored (e.g., non-preferred or not recommended) for UE-B transmission. In this case, the coordination information can include at least one of: at least one resource that is recognized as favored by the first wireless communication device for the second wireless communication device to transmit the sidelink-related data, and/or at least one resource that is recognized as disfavored by the first wireless communication device for the second wireless communication device to transmit the sidelink-related data.

In some implementations, the at least one resource favored for the second wireless communication device's transmission can meet/satisfy all of or at least one of the following conditions: a resource determined based on sidelink-related data reference signal received power (RSRP) measurement and a RSRP threshold; a resource determined based on a priority value thereof and a priority value of a resource of the third wireless communication device; a resource determined based on a distance threshold; and/or a resource determined based on a half-duplex limit/restriction. The at least one resource disfavored by the second wireless communication device can include at least one of: a resource determined based on sidelink related data RSRP measurement and a RSRP threshold; a resource determined based on a priority value thereof and a priority value of a resource of the third wireless communication device; a resource determined based on a distance threshold; and/or a resource determined based on a half-duplex limit.

In some implementations, the coordination information can include at least one of: one or more of time-domain locations and/or frequency-domain locations of the at least one resource favored for the second wireless communication device; one or more of time-domain locations and/or frequency-domain locations of the at least one resource disfavored for the second wireless communication device; a time and frequency resource conflict ratio; sequence preference indication; one or more favored physical resource block (PRB); one or more disfavored PRB; measurement information of a third wireless communication device (e.g., another UE); a transmission priority of sidelink-related data of the third wireless communication device; one or more of identification (ID) information, distance information, and/or location information of the third wireless communication device; and/or intended transmission time and frequency location of the first wireless communication device.

In various arrangements, the coordination information can include one or more resources and/or a recommendation level associated with the one or more resources. In this case, at least one of a value range and/or threshold of the recommendation level can be configured. For example, the configuring of the value range and/or the threshold can be performed/determined/executed using at least one of a media access control (MAC) layer, radio resource control (RRC) layer, PC5 signaling (PC5-S), application layer, and/or another higher layer (e.g., SL LPP, etc.).

In some implementations, the recommendation level can be determined based on at least one of: one or more of time-domain location and/or frequency-domain location of the one or more favored resources; one or more of time-domain location and/or frequency-domain location of the one or more disfavored resources; a time and frequency resource conflict ratio; sequence preference indication; one or more favored PRB; one or more disfavored PRB; measurement information of a third wireless communication device; a transmission priority of sidelink-related data of the third wireless communication device; one or more of identification information, distance information, and/or location information of the third wireless communication device; and/or intended transmission time and frequency location of the first wireless communication device.

In some arrangements, for instance, in resource recommendation by partitioning/region, the coordination information can include one or more resources and/or recommendation indication (e.g., binary and/or non-binary recommendation) associated with each of the one or more resources. For example, the second wireless communication device can receive/obtain time-domain location and frequency-domain location of resources from the first wireless communication device, such as in a selection window of the second wireless communication device with the recommendation indication.

In this case, the one or more resources can be from a resource pool (e.g., SL resource pool or SL-PRS resource pool). Different resources may be associated with different resource pool index. Each of the one or more resources can be identified by a resource pool index (e.g., SL resource pool index or SL-PRS resource pool index) identifying the resource pool in the coordination information. In some cases, the sidelink-related resource pool may overlap with the first wireless communication device and/or one or more other wireless communication devices' resource pool.

In certain arrangements (e.g., various configurations for resource recommendation), the second wireless communication device can receive the coordination information according to at least one of the coordination information reporting methods (e.g., binary, non-binary, binary by region, non-binary by region, etc.). For instance, for a binary coordination information reporting method, one or more resources can be recognized/considered as favored or disfavored. In another example, for non-binary coordination information reporting method, the value range or threshold of the recommendation level can be configured. In further example, for binary or non-binary by region, at least one recommendation indication can be provided/included/contained in the coordination information based on certain time-frequency resources.

In various implementations, the at least one of the coordination information reporting methods can include or correspond to at least one of: one or more coordination information reporting methods reported by at least one of the first wireless communication device and/or second wireless communication device as supported; one or more coordination information reporting method reported/requested by at least one of the first wireless communication device and/or second wireless communication device as preferred; and/or a coordination information reporting method configured by the network; and/or a default coordination information reporting method.

In some arrangements, the coordination information may be received by the second wireless communication device in response to a trigger. For example, the trigger may include the second wireless communication device sending/transmitting a request for the coordination information to the first wireless communication device (e.g., SL-PRS IUC trigger). The request can be carried in at least one of: a MAC CE; sidelink control information (SCI); and/or higher layer signaling.

In some implementations, the request can include at least one of: a sidelink data inter-UE coordination (IUC) and/or sidelink position reference signal (SL-PRS) IUC indicator; a coordination information scheme indicator; a providing/requesting indicator; a sidelink resource pool index and/or a SL-PRS resource pool index; a priority value for the sidelink related data; a frequency location and a number of at least one sub-channels for the sidelink related data; a resource reservation interval for the sidelink related data; a starting time location and an ending time location of a resource selection window of the second wireless communication device; a resource set type; one or more of identification information, distance information, and/or location information of the second wireless communication device; a distance threshold; a sequence identifier for a sidelink reference signal; an on-off indicator; a number of measurement instances; an automatic gain control (AGC) gap symbol; and/or a cast type.

In various implementations, a certain condition (e.g., other than explicit request) can be a trigger. For example, the trigger corresponds to a condition being met/satisfied; and/or the trigger can be provided by a network (e.g., wireless communication node, BS, gNB, and/or LMF) to at least one of the first wireless communication device and/or the second wireless communication device.

In certain arrangements, the first wireless communication device can transmit the coordination information in a first selection window (e.g., sensing/selection window of the UE-A used for SL transmission carrying SL-PRS inter-UE coordination information). In this case, the second wireless communication device can determine/identify the at least one resource in a second selection window (e.g., sensing/selection window of UE-B for determining the set of resources). In various embodiments, at least one of: a timeline relationship between the first selection window and the second selection window can be defined or configured by the network and/or at least one of the first wireless communication device and/or the second wireless communication device; in some cases, the first selection window and the second selection window may not overlap; in some other cases, at least a portion/part of the first selection window can overlap with at least a portion of the second selection window; and/or the second wireless communication device can be configured to choose/select/determine whether or not to consider the coordination information.

In some implementations, a sensing window for the first wireless communication device to transmit the coordination information can have or include a window size that is larger/greater than or equal to a resource reservation interval of the second wireless communication device for transmitting the sidelink-related data. In various arrangements, the coordination information is carried in at least one of: a MAC CE; SCI; and/or higher layer signaling.

In some arrangements, the coordination information can include at least one of: a sidelink data IUC and/or SL-PRS IUC indicator; a providing/requesting indicator; a sidelink resource pool index and/or a SL-PRS resource pool index; a coordination information scheme indicator; a priority value for a conflict transmission of a third wireless communication device; reference resource location; first resource location; a frequency location and a lowest sub-channel index; a number of sub-channels for the sidelink-related data; one or more resource reservation interval for the sidelink related data; a starting time location and an ending time location of a resource selection window of the second wireless communication device; a resource set type; relationship between at least one recommendation level and at least one time-frequency region; relationship between the SL-data/SL-PRS resource pool index and the at least one time-frequency region; a sequence identifier for a sidelink reference signal; an on-off indicator; a number of measurement instances; an AGC symbol, gap symbol; a cast type; one or more of identification information, distance information, and/or location information of the first wireless communication device and/or of the third wireless communication device (e.g., at least one other wireless communication device which conflicts with UE-B/the second wireless communication device); a distance between the first wireless communication device and the third wireless communication device; and/or a distance between the second wireless communication device and the third wireless communication device.

In certain arrangements, the coordination information can include at least one of: at least one resource expected to collide (e.g., resource conflict) with one or more resources reserved by the second wireless communication device; at least one resource that may potentially collide with the one or more resources reserved by the second wireless communication device; and/or at least one resource that can be detected by the first wireless communication device to collide with the one or more resources reserved by the second wireless communication device.

In some implementations, the first wireless communication device can determine that a resource collides with a first reserved resource and/or multiple reserved resources (e.g., design for one or more expected, potential, and/or detected resource conflict indication) of the second wireless communication device in response to determining at least one of: at least a portion of the first reserved resource overlaps with the resource that is reserved by a third wireless communication device; and/or the first reserved resource is located in a slot in which the first wireless communication device is incapable of receiving the sidelink-related data based on half-duplex operation, for example.

In some cases, the coordination information can be carried in at least one of: a physical sidelink feedback channel (PSFCH); a MAC CE, SCI, and/or higher layer signaling. In some aspects, the coordination information can be carried on the PSFCH, and in some cases, at least one of: the PSFCH can occupy one or more orthogonal frequency division multiplexing (OFDM) symbols; the PSFCH can occupy one or more PRBs; and/or a PSFCH sequence can be determined based on at least one of association relationship between conflict indication and sequence cyclic shift and/or increasing a maximum number of cyclic shifts.

In various arrangements, the coordination information can include one or more recommended SL-PRS characteristics and/or SL-PRS configurations for the second wireless communication device. The SL-PRS characteristic and/or SL-PRS configuration can include at least one of: favored and/or disfavored SL-PRS configurations to the second wireless communication device; a recommendation level for the SL-PRS configurations; preference indicated in IUC information associated with at least one of the SL-PRS configurations; and/or preference indicated in IUC information associated with all of the SL-PRS configurations.

In some implementations, SL-PRS configuration may include at least one of: periodicity, resource bandwidth, repetition factor, SL-PRS muting pattern, SL-PRS comb size, number of SL-PRS resource symbols, QCL information, start/end time of SL-PRS transmission, range of SL-PRS MCS value, range of the number of SL-PRS sub-channels, maximum SL-PRS (re-) transmission number, SL-PRS MaxTxPower, SL-PRS CRₗᵢₘᵢₜ, SL-PRS resource set ID, SL-PRS resource ID, SL-PRS AGC symbol and gap symbol, and/or cyclic prefix length of SL-PRS resource, among others.

In some arrangements, the coordination information can include coordination information transfer framework (e.g., SL-PRS IUC transfer framework) applicable to SL-PRS measurement requests and/or reports.

At 1808, the second wireless communication device can transmit the sidelink-related data using the at least one resource to the first wireless communication device and/or at least one other wireless communication device (e.g., the third wireless communication device, etc., not limited to UE-A). At 1810, the first wireless communication device (or the at least one other wireless communication device) can receive the sidelink-related data from the second wireless communication device, such as using the at least one resource. In various implementations, the second wireless communication device transmission (e.g., UE-B transmission) may not be intended/oriented for UE-A, nor for one wireless communication device, such that the UE-B transmission can involve/include or correspond to unicast, groupcast, and/or broadcast transmission.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method for managing sidelink communications between a first wireless communication device and a second wireless communication device, comprising:
receiving, by the second wireless communication device from the first wireless communication device, coordination information for sidelink positioning among a plurality of wireless communication devices;
determining, by the second wireless communication device, at least one resource for transmitting sidelink-related data; and
transmitting, by the second wireless communication device to the first wireless communication device or at least one other wireless communication device, the sidelink-related data using the at least one resource.

2. The method of claim 1, wherein
the coordination information is determined by the first wireless communication device; and
the sidelink-related data comprises at least one of sidelink positioning reference signaling or sidelink data.

3. The method of claim 1, wherein the coordination information comprises one of:
at least one resource are recognized as favored by the first wireless communication device for the second wireless communication device to transmit the sidelink-related data; or
at least one resource are recognized as disfavored by the first wireless communication device for the second wireless communication device to transmit the sidelink-related data.

4. The method of claim 3, wherein the at least one resource favored for the second wireless communication device to transmit the sidelink-related data meets all of or at least one of the following conditions:
a resource determined based on sidelink related data Reference Signal Received Power (RSRP) measurement and a RSRP threshold;
a resource determined based on a priority value thereof and a priority value of a resource of the third wireless communication device;
a resource determined based on a distance threshold; or
a resource determined based on a half-duplex limit; or
the at least one resource disfavored by the second wireless communication device to transmit the sidelink-related data comprises at least one of:
a resource determined based on sidelink related data Reference Signal Received Power (RSRP) measurement and a RSRP threshold;
a resource determined based on a priority value thereof and a priority value of a resource of the third wireless communication device;
a resource determined based on a distance threshold; or
a resource determined based on a half-duplex limit.

5. (canceled)

6. The method of claim 3, wherein the coordination information further comprises at least one of:
one or more of time-domain location or frequency-domain location of the at least one resource favored for the second wireless communication device to transmit the sidelink-related data;
one or more of time-domain location or frequency-domain location of the at least one resource disfavored for the second wireless communication device;
a time and frequency resource conflict ratio;
sequence preference indication;
one or more favored Physical Resource Block (PRB);
one or more disfavored PRB;
measurement information of a third wireless communication device;
a transmission priority of sidelink-related data of the third wireless communication device;
one or more of identification information, distance information, or location information of the third wireless communication device; or
intended transmission time and frequency location of the first wireless communication device.

7. The method of claim 1, wherein
the coordination information comprises one or more resources and a recommendation level associated with the one or more resources;
the method further comprising configuring at least one of a value range or threshold of the recommendation level; and
the configuring is performed using at least one of a Media Access Control (MAC) layer, Radio Resource Control (RRC) layer, PC5 signaling (PC5-S), application layer, or another higher layer, wherein
the one or more resources comprises at least one of: one or more favored resources or one or more disfavored resources, and the recommendation level is determined based on at least one of:
one or more of time-domain location or frequency-domain location of the one or more favored resources;
one or more of time-domain location or frequency-domain location of the one or more disfavored resources;
a time and frequency resource conflict ratio;
sequence preference indication;
one or more favored Physical Resource Block (PRB);
one or more disfavored PRB;
measurement information of a third wireless communication device;
a transmission priority of sidelink-related data of the third wireless communication device;
one or more of identification information, distance information, or location information of the third wireless communication device; or
intended transmission time and frequency location of the first wireless communication device.

8. (canceled)

9. The method of claim 1, wherein
the coordination information comprises one or more resources and recommendation indication associated with each of the one or more resources; and
the method further comprising receiving, by the second wireless communication device from the first wireless communication device, time-domain location and frequency-domain location of resources in a selection window of the second wireless communication device with the recommendation indication.

10. The method of claim 1, wherein
the coordination information is received by the second wireless communication device according to one of a plurality of coordination information reporting methods; and
the one of the plurality of coordination information reporting methods is one of:
one or more coordination information reporting method reported by at least one of the first wireless communication device or second wireless communication device as supported;
one or more coordination information reporting method reported/requested by at least one of the first wireless communication device or second wireless communication device as preferred; or
a coordination information reporting method configured by the network; or
a default coordination information reporting method.

11. The method of claim 1, wherein the coordination information is received by the second wireless communication device in response to a trigger.

12. The method of claim 11, wherein the trigger comprises sending, by the second wireless communication device to the first wireless communication device, a request for the coordination information, wherein
the request is carried in at least one of:
a Media Access Control (MAC) Control Element (CE);
Sidelink Control Information (SCI); or
higher layer signaling; or
the request comprises at least one of:
a sidelink data Inter-User Equipment Coordination (IUC) or Sidelink Position Reference Signal (SL-PRS) IUC indicator;
a coordination information scheme indicator;
a providing/requesting indicator;
a sidelink resource pool index or a SL-PRS resource pool index;
a priority value for the sidelink related data;
a frequency location and a number of at least one sub-channels for the sidelink related data;
a resource reservation interval for the sidelink related data;
a starting time location and an ending time location of a resource selection window of the second wireless communication device;
a resource set type;
one or more of identification information, distance information, or location information of the second wireless communication device;
a distance threshold;
a sequence identifier for a sidelink reference signal;
an on-off indicator;
a number of measurement instances;
an Automatic Gain Control (AGC) gap symbol; or
a cast type.

13. (canceled)

14. (canceled)

15. The method of claim 11, wherein
the trigger corresponds to a condition being met; or
the trigger is provided by a network to at least one of the first wireless communication device or the second wireless communication device.

16. The method of claim 1, wherein
the first wireless communication device transmits the coordination information in a first selection window;
the second wireless communication device determines the at least one resource in a second selection window;
one of:
a timeline relationship between the first selection window and the second selection window is defined or configured by the network or at least one of the first wireless communication device or the second wireless communication device;
the first selection window and the second selection window do not overlap;
at least a portion of the first selection window overlaps with at least a portion of the second selection window; or
the second wireless communication device is configured to choose whether or not to consider the coordination information.

17. The method of claim 1, wherein a sensing window for the first wireless communication device to transmit the coordination information has a window size that is larger or equal to a resource reservation interval of the second wireless communication device for transmitting the sidelink-related data.

18. The method of claim 1, wherein the coordination information is carried in at least one of:
a Media Access Control (MAC) Control Element (CE);
Sidelink Control Information (SCI); or
higher layer signaling.

19. The method of claim 1, wherein the coordination information comprises at least one of:
a sidelink data IUC or Sidelink Position Reference Signal (SL-PRS) IUC indicator;
a providing/requesting indicator;
a sidelink resource pool index or a SL-PRS resource pool index;
a coordination information scheme indicator;
a priority value for a conflict transmission of a third wireless communication device;
reference resource location;
first resource location;
a frequency location and a lowest sub-channel index;
a number of sub-channels for the sidelink-related data;
one or more resource reservation interval for the sidelink related data;
a starting time location and an ending time location of a resource selection window of the second wireless communication device;
a resource set type;
relationship between at least one recommendation level and at least one time-frequency region;
relationship between the SL-data/SL-PRS resource pool index and the at least one time-frequency region;
a sequence identifier for a sidelink reference signal;
an on-off indicator;
a number of measurement instances;
an Automatic Gain Control (AGC) symbol, gap symbol;
a cast type;
one or more of identification information, distance information, or location information of the first wireless communication device and/or of the third wireless communication device;
a distance between the first wireless communication device and the third wireless communication device; or
a distance between the second wireless communication device and the third wireless communication device; or
the coordination information comprises:
coordination information transfer framework applicable to Sidelink Position Reference Signal (SL-PRS) measurement request and report.

20. The method of claim 1, wherein the coordination information comprises at least one of:
at least one resource expected to collide with one or more resources reserved by the second wireless communication device;
at least one resource that potentially collides with the one or more resources reserved by the second wireless communication device; or
at least one resource that is detected by the first wireless communication device to collide with the one or more resources reserved by the second wireless communication device.

21. The method of claim 20, wherein the first wireless communication device determines that a resource collides with a first reserved resource or multiple reserved resources of the second wireless communication device in response to determining at least one of:
at least a portion of the first reserved resource overlaps with the resource that is reserved by a third wireless communication device; or
the first reserved resource is located in a slot in which the first wireless communication device is incapable of receiving the sidelink-related data based on half-duplex operation.

22. The method of claim 20, wherein the coordination information is carried in at least one of:
Physical Sidelink Feedback Channel (PSFCH);
a Media Access Control (MAC) Control Element (CE);
Sidelink Control Information (SCI); or
Higher layer signaling; or
the coordination information is carried on Physical Sidelink Feedback Channel (PSFCH), and at least one of:
the PSFCH occupies one or more Orthogonal Frequency Division Multiplexing (OFDM) symbols;
the PSFCH occupies one or more Physical Resource Blocks (PRBs); or
a PSFCH sequence is determined based on at least one of association relationship between conflict indication and sequence cyclic shift or increasing a maximum number of cyclic shifts.

23. (canceled)

24. The method of claim 1, wherein the coordination information comprises recommended Sidelink Position Reference Signal (SL-PRS) characteristics or SL-PRS configurations for the second wireless communication device, wherein the SL-PRS characteristic or SL-PRS configuration comprises at least one of:
favored and/or disfavored SL-PRS configurations to the second wireless communication device;
a recommendation level for the SL-PRS configurations;
preference indicated in IUC information associated with at least one of the SL-PRS configurations; or
preference indicated in IUC information associated with all of the SL-PRS configurations, wherein
the SL-PRS configurations include at least one of: periodicity, a resource bandwidth, a repetition factor, an SL-PRS muting pattern, an SL-PRS comb size, a number of SL-PRS resource symbols, Quasi Co-Location (QCL) information, start/end time of SL-PRS transmission, a range of SL-PRS modulation and coding scheme (MCS) value, a range of a number of SL-PRS sub-channels, a maximum SL-PRS transmission number, an SL-PRS maximum transmission power (MaxTxPower), an SL-PRS channel occupancy ratio (CRₗᵢₘᵢₜ), an SL-PRS resource set ID, an SL-PRS resource ID, an SL-PRS AGC symbol and gap symbol, or a cyclic prefix length of SL-PRS resource.

25-28. (canceled)

29. A wireless communication method for managing sidelink communications between a first wireless communication device and a second wireless communication device, comprising:
sending, by the first wireless communication device to the second wireless communication device, coordination information for coordinating sidelink positioning among a plurality of wireless communication devices, wherein the second wireless communication device determines at least one resource for transmitting sidelink-related data; and
receiving, by the first wireless communication device or at least one other wireless communication device from the second wireless communication device, the sidelink-related data using the at least one resource.

30. (canceled)

31. (canceled)
